(19) United States
(12) Patent Application Publication
(10) Pub. No.: US 2006/0005898 A1
(43) Pub. Date: Jan. 12, 2006

(54) Anisotropic nanocomposite rare earth permanent magnets and method of making

(76) Inventors: Shiqiang Liu, Springboro, OH (US); Don Lee, Springboro, OH (US)

Correspondence Address: DINSMORE & SHOHL LLP, One Dayton Centre, One South Main Street, Suite 1300, Dayton, OH, 45402-2023, US

(21) Appl. No.: 11/171,521

(22) Filed: Jun. 30, 2005

Related U.S. Application Data
(60) Provisional application No. 60/584,009, filed on Jun. 30, 2004.

(51) Int. Cl. H01F 1/055

(52) U.S. Cl. 148/105; 148/302

(57) ABSTRACT

A bulk, anisotropic, nanocomposite, rare earth permanent magnet. Methods of making the bulk, anisotropic, nanocomposite, rare earth permanent magnets are also described.

### CROSS-REFERENCE TO RELATED APPLICATIONS

This application claims the benefit of U.S. Provisional Application Ser. No. 60/584,009, ANISOTROPIC NANOCOMPOSITE RARE EARTH PERMANENT MAGNETS AND METHOD OF MAKING, filed Jun. 3, 2004.

### BACKGROUND OF THE INVENTION

The present invention relates to nanocomposite magnets, and more particularly, to anisotropic nanocomposite rare earth permanent magnets which exhibit good magnetic performance.

Permanent magnet materials have been widely used in a variety of applications such as automotive, aircraft and spacecraft systems, for example, in motors, generators, sensors, and the like. One type of potentially high performance permanent magnet is a nanocomposite Nd₂Fe₁₄B/α-Fe magnet which contains a magnetically soft α-Fe phase having a higher saturation magnetization than the magnetically hard Nd₂Fe₁₄B phase. Such magnets have a saturation magnetization higher than 16 kG, and thus have the potential to be developed into high-performance rare earth permanent magnets.

However, when formulating such magnets, it is difficult to obtain good grain alignment, which leads to poor magnetic properties. To date, only partial grain alignment has been achieved in nanocomposite magnets. Therefore, there is a need to improve grain alignment in nanocomposite rare earth magnets.

The rare earth content, for example the Nd content in Nd—Fe—B magnets, affects the ability to obtain the proper magnetic properties. As shown in FIG. 1, the Nd content in the magnet alloy determines the type of Nd—Fe—B magnets in a chemical equilibrium condition. Type I magnets have a main Nd₂Fe₁₄B phase and a minor Nd-rich phase and have an effective Nd content of greater than 11.76 atomic percent (at %). By “effective Nd (or rare earth) content,” it is meant the metallic part of the total Nd (or rare earth) content, excluding Nd (or rare earth) oxide, such as Nd₂O₃. Type II magnets have only the Nd₂Fe₁₄B phase, and have an effective Nd content equal to stoichiometric 11.76 at %. Type III magnets have a Nd₂Fe₁₄B phase and a magnetically soft α-Fe phase. If the grain size is in the nanometer range, Type I and Type II magnets are usually referred to as nanocrystalline magnets, while Type III magnets are referred to as nanocomposite magnets.

An important feature of Nd₂Fe₁₄B/α-Fe magnets is that, in a chemical equilibrium condition, they should not contain any Nd-rich phase. However, the Nd-rich phase is important when making Nd—Fe—B type magnets as it ensures that full density can be reached when forming conventional sintered and hot-compacted and hot-deformed Nd—Fe—B magnets. The Nd-rich phase also provides high coercivity in such magnets, ensures hot deformation without cracking, and facilitates the formation of the desired crystallographic texture via hot deformation so that high-performance anisotropic magnets can be made.

Although full density, relatively high coercivity, and successful hot deformation can be achieved in nanocomposite magnets such as Nd₂Fe₁₄B/α-Fe magnets by using methods described in U.S. patent application Ser. No. 20040025974, which is incorporated herein by reference, only partial crystallographic texture can be achieved in such magnets.

Accordingly, there is a need in the art for an improved method of producing nanocomposite rare earth permanent magnets which provides good grain alignment, full density values, and high magnetic performance.

### SUMMARY OF THE INVENTION

The present invention meets that need by providing nanocomposite rare earth permanent magnets which exhibit the improved grain alignment and magnetic properties and which may be synthesized by compaction hot deformation. By “nanocomposite magnet”, it is meant a magnet comprising a magnetically hard phase and a magnetically soft phase, where at least one of the phases has a nanograin structure, in which the grain size is smaller than one micrometer.

The nanocomposite, rare earth permanent magnet of the present invention comprises at least one magnetically hard phase and at least one magnetically soft phase, wherein the at least one magnetically hard phase comprises at least one rare earth-transition metal compound, wherein the composition of the magnetically hard phase specified in atomic percentage is RₓT_{100-x-y}M_{y} and wherein R is selected from rare earths, yttrium, scandium, or combinations thereof, wherein T is selected from one or more transition metals, wherein M is selected from an element in groups IIIA, IVA, VA, or combinations thereof, and wherein x is greater than a stoichiometric amount of R in a corresponding rare earth-transition metal compound, wherein y is 0 to about 25, and wherein the at least one magnetically soft phase comprises at least one soft magnetic material containing Fe, Co, or Ni.

Another aspect of the invention is a method of making nanocomposite, rare earth permanent magnets. One method comprises: providing at least one powdered rare earth-transition metal alloy wherein the rare earth-transition metal alloy has an effective rare earth content in an amount greater than a stoichiometric amount in a corresponding rare earth-transition metal compound; providing at least one powdered material selected from a rare earth-transition metal alloy wherein the rare earth-transition metal alloy has an effective rare earth content in an amount less than a stoichiometric amount in a corresponding rare earth-transition metal compound; a soft magnetic material; or combinations thereof; blending the at least one powdered rare earth-transition metal alloy and the at least one powdered material; and performing at least one operation selected from compacting the blended at least one powdered rare earth-transition metal alloy and at least one powdered material to form a bulk, isotropic, nanocomposite, rare earth permanent magnet; or hot deforming the bulk, isotropic, nanocomposite, rare earth permanent magnet, or the blended at least one powdered rare earth-transition metal alloy and at least one powdered material, to form the bulk, anisotropic, nanocomposite, rare earth permanent magnet.

Alternatively, the method comprises: providing at least one powdered rare earth-transition metal alloy wherein the rare earth-transition metal alloy has an effective rare earth content in an amount not less than a stoichiometric amount in a corresponding rare earth-transition metal compound; coating the at least one powdered rare earth-transition metal alloy with at least one soft magnetic material; and performing at least one operation selected from compacting the coated at least one powdered rare earth-transition metal alloy; or hot deforming the compacted coated at least one powdered rare earth-transition metal alloy, or the coated at least one powdered rare earth-transition metal alloy.

### BRIEF DESCRIPTION OF THE DRAWINGS

FIG. 1 is a graph illustrating theoretical (BH)ₘₐₓ vs. Nd content and illustrating three different types of Nd—Fe—B magnets;

FIG. 2 is a graph illustrating demagnetization curves of a hot compacted and hot deformed nanocomposite magnet made using a single alloy powder of Nd_{10.8}Pr_{0.6}Dy_{0.2}Fe_{76.3}Co_{6.3}Ga_{0.2}B_{5.6}.

FIG. 3 is a graph illustrating demagnetization curves of a hot compacted and hot deformed nanocomposite magnet made using a single alloy powder of Nd₅Pr₅Dy₁Fe₇₃Co₆B₁₀.

FIG. 4 is a flowchart illustrating one embodiment of the method of forming composite magnets of the present invention.

FIG. 5 is a graph illustrating demagnetization curves of a hot compacted and hot deformed nanocomposite magnet made using an alloy powder having a rare earth content equal to 13.5 at % and an alloy powder having a rare earth content of 11 at %;

FIG. 6 is a graph illustrating demagnetization curves of a hot compacted and hot deformed nanocomposite magnet made using an alloy powder having a rare earth content of 13.5 at % and an alloy powder having a rare earth metal content of 6 at %;

FIG. 7 is a graph illustrating demagnetization curves of a hot compacted and hot deformed nanocomposite magnet made using an alloy powder having a rare earth content of 13.5 at % and an alloy powder having a rare earth content of 4 at %;

FIG. 8 is a flowchart illustrating a second embodiment of the method of forming composite magnets of the present invention.

FIG. 9 are SEM micrographs of α-Fe powder particles used in making nanocomposite Nd—Fe—B/α-Fe magnets.

FIG. 10 is a SEM micrograph showing cross sections of α-Fe powder particles used in making nanocomposite Nd—Fe—B/α-Fe magnets.

FIG. 11 shows the result of SEM/EDS analysis of the α-Fe powder particles used in making nanocomposite Nd—Fe—B/α-Fe magnets.

FIG. 12 shows the x-ray diffraction pattern of a random powder crushed from hot pressed and hot deformed magnet synthesized using Nd_{13.5}Fe₈₀Ga_{0.5}B₆ blended with 8.3 wt % α-Fe powder.

FIG. 13 shows an SEM micrograph of a hot pressed Nd_{13.5}Fe₈₀Ga_{0.5}B_{6/}α-Fe [91.7 wt %/8.3 wt %] magnet demonstrating Nd—Fe—B ribbons and the α-Fe phase among them.

FIG. 14 shows an SEM micrograph of the same magnet as shown in FIG. 13, but with larger magnification.

FIG. 15 shows demagnetization curves of a hot pressed Nd_{13.5}Fe₈₀Ga_{0.5}B₆/α-Fe [92 wt %/8 wt %] magnet.

FIG. 16 shows an SEM back scattered electron image of a hot deformed Nd_{13.5}Fe₈₀Ga_{0.5}B₆/α-Fe [91.7 wt %/8.3 wt %] magnet.

FIG. 17 shows an SEM second electron image of a hot deformed Nd₁₄Fe_{79.5}Ga_{0.5}B₆/α-Fe [92 wt %/8 wt %] magnet demonstrating a layered α-Fe phase.

FIG. 18 shows demagnetization curves of a hot pressed and hot deformed Nd_{13.5}Fe₈₀Ga_{0.5}B₆/α-Fe [98 wt %/2 wt %] magnet.

FIG. 19 shows demagnetization curves of a hot pressed and hot deformed Nd_{13.5}Fe₈₀Ga_{0.5}B₆/α-Fe [91.7 wt %/8.3 wt %] magnet.

FIG. 20 shows an SEM micrograph of fracture surface of a hot pressed and hot deformed Nd_{13.5}Fe₈₀Ga_{0.5}B₆/α-Fe [92.1 wt %/7.9 wt %] magnet, demonstrating elongated and aligned grains.

FIG. 21 shows a TEM micrograph of a hot pressed and hot deformed Nd₁₄Fe_{79.0}Ga_{0.5}B₆/α-Fe [95 wt %/5 wt %] magnet.

FIG. 22 shows a TEM micrograph of the same composite magnet as shown in FIG. 21.

FIG. 23 shows a comparison of the XRD patterns of bulk anisotropic magnets of (1) a hot deformed nanocomposite Nd_{10.8}Pr_{0.6}Dy_{0.2}Fe_{76.1}Co_{6.3}Ga_{0.2}Al_{0.2}B_{5.6} magnet synthesized using an alloy powder with TRE=13.5 at % and an alloy powder with TRE=6 at %; (2) a hot deformed Nd_{13.5}Fe₈₀Ga_{0.5}B₆/α-Fe [91.7 wt %/8.3 wt %] magnet synthesized using an alloy powder with Nd=13.5 at % blended with 8.3 wt % α-Fe powder, (3) a commercial sintered Nd—Fe—B magnet.

FIG. 24 shows the effect of α-Fe content on Bᵣ and _{M}H_{C} of nanocomposite Nd—Fe—B/α-Fe magnets.

FIG. 25 shows the effect of α-Fe content on (BH)max of nanocomposite Nd—Fe—B/α-Fe magnets.

FIG. 26 shows demagnetization curves of a Nd_{12.5}Dy_{1.5}Fe_{79.5}Ga_{0.5}B₆/α-Fe [87.1 wt %/12.9 wt %] magnet.

FIG. 27 shows the effect of α-Fe content on Bᵣ and _{M}H_{C} of composite Nd_{12.5}Dy_{1.5}Fe_{79.5}Ga_{0.5}B₆/α-Fe [87.1 wt %/12.9 wt %] magnets.

FIG. 28 shows the effect of α-Fe content on (BH)max of composite Nd_{12.5}Dy_{1.5}Fe_{79.5}Ga_{0.5}B₆/α-Fe [87.1 wt %/12.9 wt %] magnets.

FIG. 29 shows an SEM micrograph of Fe—Co powder used in making composite Nd—Fe—B/Fe—Co magnets.

FIG. 30 shows an SEM back scattered electron image of a Nd_{13.5}Fe₈₀Ga_{0.5}B₆/Fe—Co [95 wt %/5 wt %] magnet with (BH)ₘₐₓ=48 MGOe.

FIG. 31 shows SEM micrographs of the Nd_{13.5}Fe₈₀Ga_{0.5}B₆/Fe—Co [95 wt %/5 wt %] magnet.

FIG. 32 shows SEM back scattered electron image of the Nd_{13.5}Fe₈₀Ga_{0.5}B₆/Fe—Co [95 wt %/5 wt %] magnet showing a Fe—Co phase.

FIG. 33 shows the results of SEM/EDS analysis of different zones for Nd_{13.5}Fe₈₀Ga_{0.5}B₆/Fe—Co [95 wt %/5 wt %] magnet.

FIG. 34 shows demagnetization curves of an anisotropic Nd₁₄Fe_{79.5}Ga_{0.5}B₆/Fe—Co [97 wt %/3 wt %] magnet.

FIG. 35 shows the effect of Fe—Co content on Bᵣ and _{M}H_{C} of composite Nd—Fe—B/Fe—Co magnets.

FIG. 36 shows the effect of Fe—Co content on (BH)max of nanocomposite Nd—Fe—B/Fe—Co magnets.

FIG. 37 shows magnetization reversal and hard/soft interface exchange coupling in composite magnets.

FIG. 38 shows a schematic illustration of the effect of the size of the soft phase on demagnetization of a hard/soft composite magnet.

FIG. 39 shows the effect of the size of the hard grains and soft phase on demagnetization of composite magnets.

FIG. 40 shows a processing flowchart of a third method of the present invention.

FIG. 41 shows a schematic illustration of a particle containing many nanograins coated with an α-Fe or Fe—Co layer.

FIG. 42 shows SEM micrographs and the result of SEM/EDS analysis of Nd_{13.5}Fe₈₀Ga_{0.5}B₆ particles after RF sputtering for 8 hours using a Fe—Co—V target.

FIG. 43 shows demagnetization curves of a nanocomposite Nd₁₄Fe_{79.5}Ga_{0.5}B₆/Fe—Co—V magnet prepared after RF sputtering for 3 hours.

FIG. 44 shows demagnetization curves of a nanocomposite Nd₁₄Fe_{79.5}Ga_{0.5}B₆/Fe—Co—V magnet prepared after DC sputtering for 8 hours.

FIG. 45 shows demagnetization curves of a nanocomposite Nd₁₄Fe_{79.5}Ga_{0.5}B₆/Fe—Co—V magnet prepared after DC sputtering for 21 hours.

FIG. 46 shows demagnetization curves of a nanocomposite Nd₁₄Fe_{79.5}Ga_{0.5}B₆/Fe—Co—V magnet prepared after DC sputtering for 21 hours.

FIG. 47 shows demagnetization curves of a nanocomposite Nd₁₄Fe_{79.5}Ga_{0.5}B₆/Fe—Co—V magnet prepared after pulsed laser deposition for 6 hours.

FIG. 48 shows SEM micrographs and the result of SEM/EDS analysis of Nd₁₄Fe_{79.5}Ga_{0.5}B₆ after chemical coating in a FeSO₄—CoSO₄—NaH₂PO₂—Na₃C₆H₅O₇ solution for 1 hour at room temperature.

FIG. 49 shows demagnetization curves of a nanocomposite Nd₁₄Fe_{79.5}Ga_{0.5}B₆/Fe—Co magnet prepared after chemical coating in a FeSO₄—CoSO₄—NaH₂PO₂—Na₃C₆H₅O₇ solution for 15 minutes.

FIG. 50 shows demagnetization curves of a nanocomposite Nd₁₄Fe_{79.5}Ga_{0.5}B₆/Fe—Co magnet prepared after chemical coating in a FeSO₄—CoSO₄—NaH₂PO₂—Na₃C₆H₅O₇ solution for 1 hour.

FIG. 51 shows demagnetization curves of a nanocomposite Nd₁₄Fe_{79.5}Ga_{0.5}B₆/Fe—Co magnet prepared after chemical coating in a FeCl₂—CoCl₂—NaH₂PO₂—Na₃C₆H₅O₇ solution for 2 hours at 50° C.

FIG. 52 shows demagnetization curves of a nanocomposite Nd₁₄Fe_{79.5}Ga_{0.5}B₆/Fe—Co magnet prepared after chemical coating in a FeCl₂—CoCl₂—NaH₂PO₂—Na₃C₆H₅O₇ solution for 1 hour.

FIG. 53 shows a schematic illustration of apparatus which could be used for electric coating.

FIG. 54 shows SEM micrographs of Nd₁₄Fe_{79.5}Ga_{0.5}B₆ after electric coating in a FeCl₂—CoCl₂—MnCl₂—H₃BO₃ solution for 0.5 hour at room temperature.

FIG. 55 shows demagnetization curves of Nd₁₄Fe_{7.5}Ga_{0.5}B₆/Fe—Co—V magnet prepared after electric coating in a FeCl₂—CoCl₂—MnCl₂—H₃BO₃ solution for 0.5 hour at room temperature under 2 volt-1 amp.

FIG. 56 shows demagnetization curves of Nd₁₄Fe_{79.5}Ga_{0.5}B₆/60 -Fe magnet prepared after electric coating in a non-aqueous LiClO₄—NaCl—FeCl₂ solution for 1.5 hour at room temperature under 60 volt-0.4 amp.

FIG. 57 shows an SEM micrograph of a Nd₁₄Fe_{79.5}Ga_{0.5}B₆/α-Fe magnet prepared after electric coating a FeCl₂—CoCl₂—MnCl₂—H₃BO₃ solution for 0.5 hour at room temperature under 3 volt-2 amp.

FIG. 58 shows theoretical (BH)ₘₐₓ vs. Nd content and the Nd range in composite Nd—Fe—B/α-Fe magnets under a non-equilibrium (metastable) condition.

FIG. 59 shows the processing flowchart of a fourth method of the present invention.

FIG. 60 shows volume % of the soft phase in nanocomposite magnets prepared using the fourth method.

FIG. 61 shows a schematic illustration of the process for synthesizing nanocomposite magnets using the fourth method.

FIG. 62 shows theoretical (BH)max vs. t/D ratio of nanocomposite Nd₂Fe₁₄B/α-Fe and Nd₂Fe₁₄B/Fe—Co magnets prepared using the fourth method.

FIG. 63 shows the relationship among the four methods of synthesizing anisotropic magnets.

FIG. 64 is a schematic illustration of the compaction step.

FIG. 65 is a schematic illustration of die upsetting.

FIG. 66 is a schematic illustrating of hot rolling.

FIG. 67 is a schematic illustration of hot extrusion.

FIG. 68 shows the microstructures of a nanocomposite Nd—Fe—B/α-Fe magnet prepared using the first method.

FIG. 69 shows an SEM fracture surface of a Fe—Co particle showing nanograins.

FIG. 70 is a schematic illustration of the microstructure for a nanocomposite magnet synthesized using the fourth method.

FIG. 71 shows the relationship of the structural characteristics of anisotropic nanocomposite magnets synthesized using the four methods of the present invention.

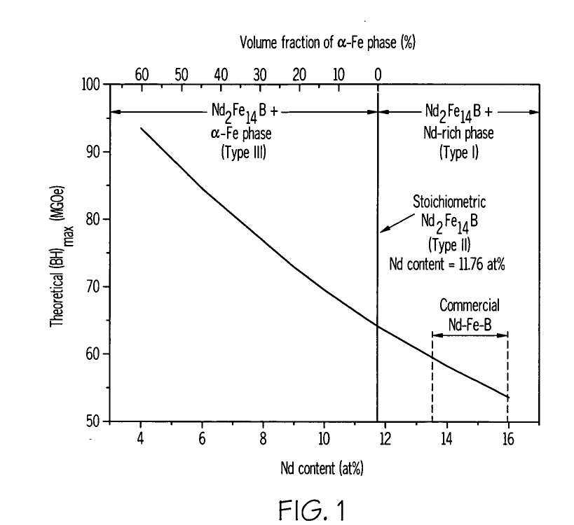

### DETAILED DESCRIPTION OF THE INVENTION

The present invention relates to anisotropic, nanocomposite rare earth permanent magnets which exhibit good grain alignment and high magnetic performance. By a “nanocomposite magnet”, it is meant a magnet comprising at least one magnetically hard phase and at least one magnetically soft phase, where at least one of the phases has a nanograin structure, in which the grain size is smaller than one micrometer.

The nanocomposite rare earth permanent magnet of the present invention comprises at least one magnetically hard phase and at least one magnetically soft phase, wherein the at least one magnetically hard phase comprises at least one rare earth-transition metal compound, wherein the composition of the magnetically hard phase specified in atomic percentage is RₓT_{100-x-y}M_{y} and wherein R is selected from rare earths, yttrium, scandium, or combination thereof, wherein T is selected from one or more transition metals, wherein M is selected from an element in groups IIIA, IVA, VA, or combinations thereof, and wherein x is greater than the stoichiometric amount of R in the corresponding rare earth-transition metal compound, and y is 0 to about 25. x is the effective rare earth content. The nanocomposite rare earth permanent magnet may be in a chemical non-equilibrium condition and, thus, may contain a rare earth-rich phase and a magnetically soft phase simultaneously. By rare earth-transition metal compound, we mean compounds containing transition metals combined with rare earths, yttrium, scandium, and combinations thereof.

The rare earth-transition metal compound can have an atomic ratio of R:T or R:T:M selected from 1:5, 1:7, 2:17, 2:14:1, or 1:12. In a nanocomposite rare earth magnet of this invention, the effective rare earth content in the magnetically hard phase specified in atomic percent is at least 7.7% if the magnetically hard phase is based on a RT₁₂ type of compound that has a ThMn₁₂ type of tetragonal crystal structure. The effective rare earth content in the magnetically hard phase specified in atomic percent is at least 11.0% if the magnetically hard phase is based on a R₂T₁₇ type of compound that has a Th₂Zn₁₇ type of rhombohedral crystal structure or a Th₂Ni₁₇ type of hexagonal crystal structure. The effective rare earth content specified in atomic percent is at least 12.0% if the magnetically hard phase is based on a R₂T₁₄M type of compound that has a Nd₂Fe₁₄B type of tetragonal crystal structure. The effective rare earth content specified in atomic percent is at least 13.0% if the magnetically hard phase is based on a RT₇ type of compound that has a TbCu₇ type of hexagonal crystal structure. The effective rare earth content specified in atomic percent is at least 17.0% if the magnetically hard phase is based on a RT₅ type of compound that has a CaCo₅ type of hexagonal crystal structure.

The rare earth-transition metal compound is preferably selected from Nd₂Fe₁₄B, Pr₂Fe₁₄B, PrCo₅, SmCo₅, SmCo₇, and Sm₂Co₁₇. The rare earth element in all of the rare earth-transition metal alloys of this invention can be substituted with other rare earth elements, mischmetal, yttrium, scandium, or combinations thereof. The transition metal element can be substituted with other transition metals or combinations thereof; and element from Groups IIIA, IVA, and VA, such as B, Al, Ga, Si, Ge, and Sb, can be added.

The magnetically soft phase in the nanocomposite magnet is preferably selected from α-Fe, Fe—Co, Fe—B, or other soft magnetic materials containing Fe, Co, or Ni.

In a composite rare earth magnet (for example Nd₂Fe₁₄B/α-Fe) that is in a chemical equilibrium condition, the effective rare earth content must be lower than the stoichiometric composition (for example 11.76 at % Nd in stoichiometric Nd₂Fe₁₄B), so the magnetically soft phase can exist. However, the nanocomposite rare earth magnets synthesized using some methods of this invention can be in a chemical non-equilibrium condition. In such a condition, a minor rare earth-rich phase, such as a Nd-rich phase, can co-exist with a magnetically soft phase, such as α-Fe or Fe—Co. Under this condition, the overall effective rare earth content is no longer a criterion to determine if a magnet is a composite magnet. Rather, the overall effective rare earth content in a nanocomposite magnet synthesized using some methods of this invention can be either less than, or equal to, or greater than that in the corresponding stoichiometric compound. For example, in a nanocomposite Nd₂Fe₁₄B/α-Fe magnet, the effective Nd content can be less than, or equal to, or greater than 11.76 at % and a minor Nd-rich phase and a magnetically soft α-Fe phase can exist in the magnet simultaneously.

The existence of the magnetically soft phase, such as α-Fe or Fe—Co, can be verified using scanning electron microscopy and energy disperse spectrum (SEM/EDS) if the soft phase is large enough. Even when the soft phase has only 0.5 vol % in the nanocomposite magnet, it can be easily identified. However, if the magnetically soft phase is very small, transmission electron microscopy and select area electron diffraction (TEM and SAED) have to be used. In addition, x-ray diffraction (XRD) can also be used to identify the α-Fe or Fe—Co phase when the amount of this phase is sufficient. However, for a bulk anisotropic Nd₂Fe₁₄B/α-Fe (or Nd₂Fe₁₄B/Fe—Co magnet), if the x-ray beam is projected to the surface that is perpendicular to the easy axis of the magnet, then the α-Fe (or Fe—Co) peak will be overlapped with the enhanced (006) peak of the main Nd₂Fe₁₄B phase. To identify the α-Fe (or Fe—Co) phase, the bulk anisotropic Nd₂Fe₁₄B/α-Fe or Nd₂Fe₁₄B/Fe—Co magnet has to be crushed and XRD performed on a non-oriented powder specimen.

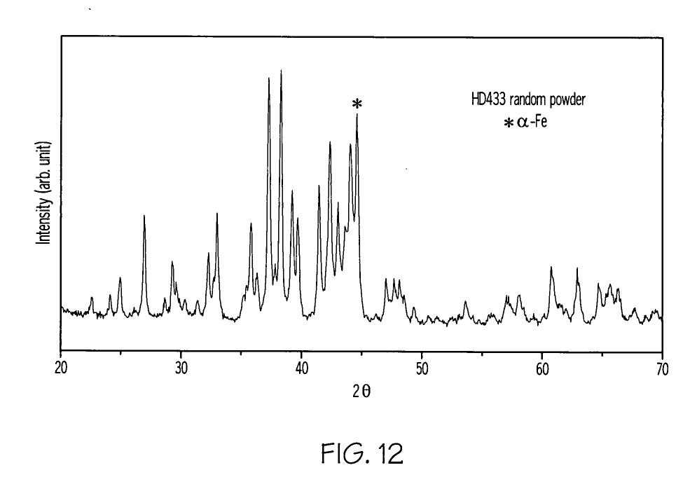

Therefore, the XRD pattern of the crushed and non-aligned powder of a bulk anisotropic nanocomposite magnet of this invention is composed of a typical pattern of the rare earth-transition metal compound (for example a tetragonal structure for Nd₂Fe₁₄B, a CaCu₅ type hexagonal structure for SmCo₅, a TbCu₇ type hexagonal structure for SmCo₇, and a Th₂Ni₁₇ type hexagonal structure or a Th₂Zn₁₇ rhombohedral structure for Sm₂Co₁₇) coupled with a pattern of the soft magnetic phase, such as α-Fe, Fe—Co, Fe—B or an alloy containing Fe, Co, or Ni, or combinations thereof, such as shown in FIG. 12.

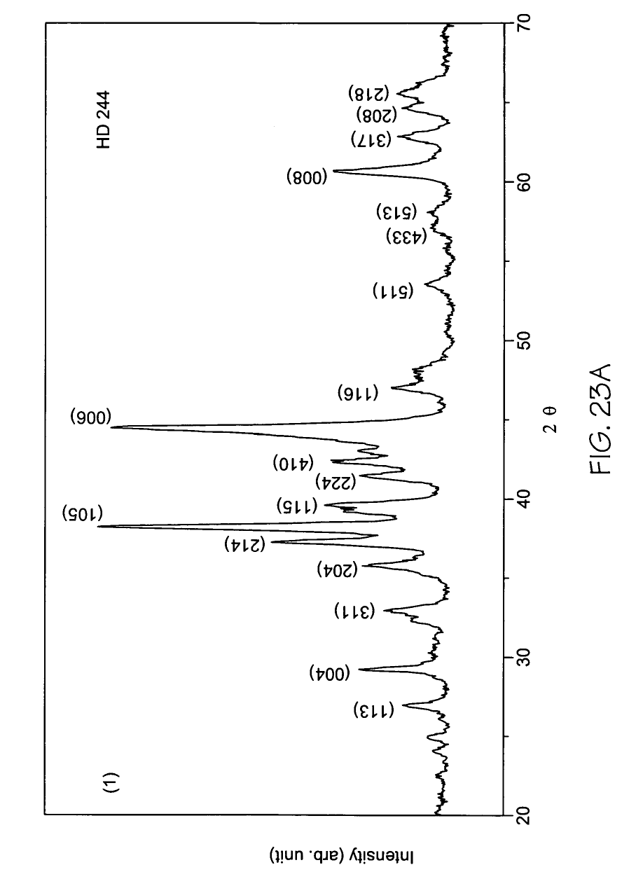

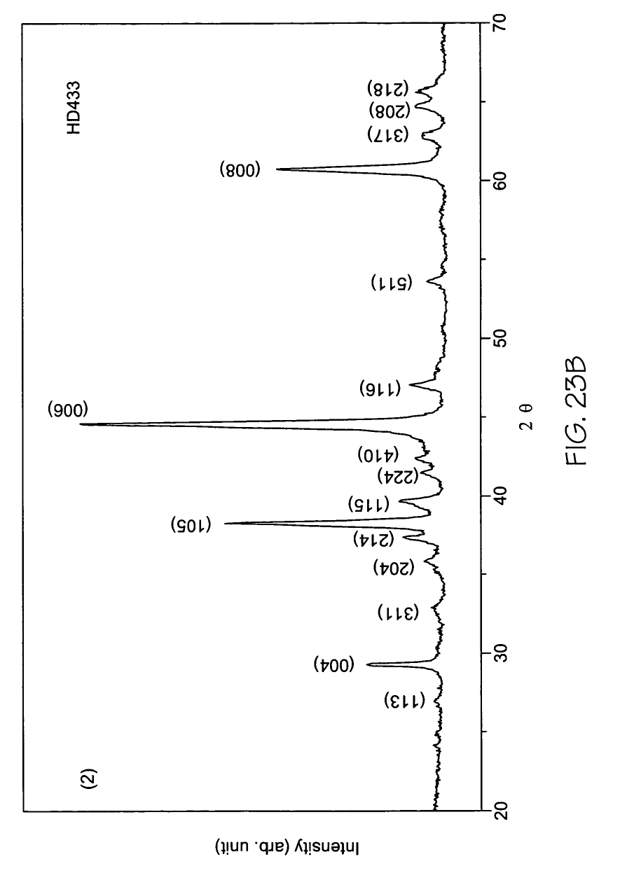

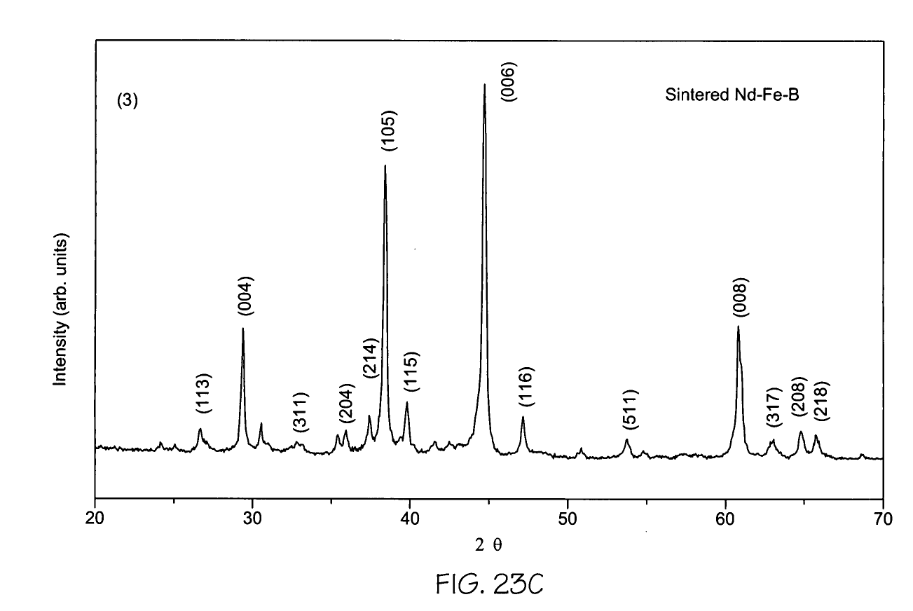

If XRD analysis is performed on the surface perpendicular to the easy direction of a bulk anisotropic magnet specimen or an aligned and resin-cured powder specimen, the XRD pattern will resemble that of a single crystal of the corresponding compound, and some enhanced diffraction peaks will be observed. For example, for a bulk anisotropic Nd₂Fe₁₄B/α-Fe magnet, enhanced diffraction peaks of (004), (006), and (008) and increased intensity ratio of (006)/(105) will be observed, as shown in FIG. 23.

As for the rare earth-rich phase, it is not easy to identify using XRD or SEM because of its small amount.

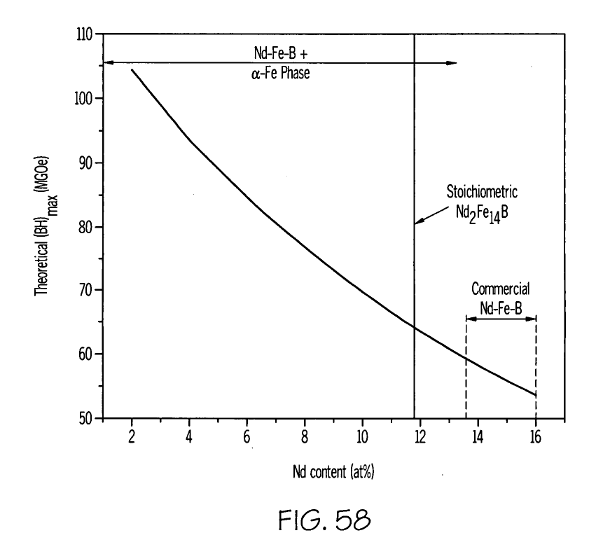

The methods of the present invention produce anisotropic nanocomposite magnets having better magnetic performance, better corrosion resistance, and better fracture resistance than conventional sintered and hot-pressed and hot deformed magnets. The magnets are also lower in cost to produce. For Nd—Fe—B/α-Fe and Nd—Fe—B/Fe₃B nanocomposite magnets, the Nd content can be in a broad range from about 2 at % to about 14 at %, as shown in FIG. 58.

Method 1

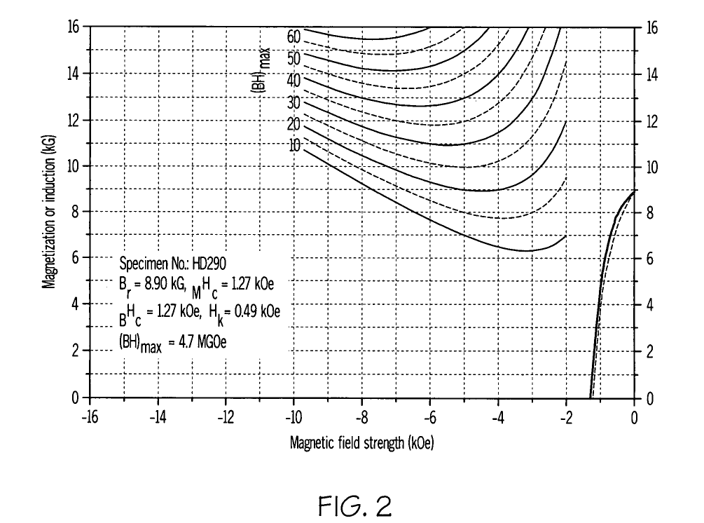

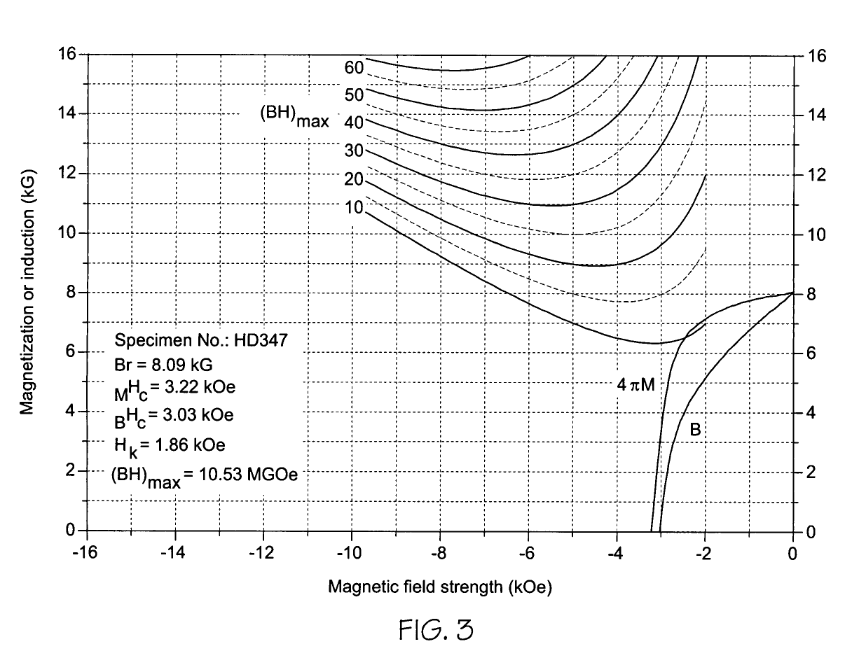

In one embodiment of the invention, the method comprises blending at least two rare earth-transition metal alloy powders, where at least one rare earth-transition metal alloy powder has an effective rare earth content in an amount greater than the stoichiometric amount of the corresponding rare earth-transition metal compound, and at least one rare earth-transition metal alloy powder has an effective rare earth content in an amount less than the stoichiometric amount of the corresponding rare earth-transition metal alloy compound. Thus, at least one rare earth-transition metal alloy powder contains a minor rare earth-rich phase, while at least one rare earth-transition metal alloy powder contains a magnetically soft phase. It has been found that during hot deformation, better grain alignment can be achieved when using a rare earth-transition metal alloy powder that contains a minor rare earth-rich phase. As a comparison, nanocomposite magnets prepared by hot compacting and hot deforming a single rare earth-transition metal alloy powder that has an effective rare earth content lower than the stoichiometric composition usually demonstrate poor magnetic properties because of the luck of a rare earth-rich phase as shown in FIGS. 2 and 3.

The rare earth-transition metal alloy preferably comprises at least one compound with an atomic ratio of R:T or R:T:M selected from 1:5, 1:7, 2:17, 2:14:1, or 1:12. The rare earth-transition metal compound is preferably selected from Nd₂Fe₁₄B, Pr₂Fe₁₄B, PrCo₅, SmCo₅, SmCo₇, and Sm₂Co₁₇. Preferably, the rare earth-transition metal alloy powders have a particle size from about 1 micrometer to about 1000 micrometer, typically from about 10 micrometer to about 500 micrometer. The rare earth-transition metal alloy powders may be prepared by using rapid solidification methods, including but not limited to melt-spinning, spark erosion, plasma spray, and atomization; or by using mechanical alloying or mechanical milling. The powder particles are either in an amorphous, or partially crystallized condition, or in a crystalline nanograin condition. If in partially crystallized or crystalline conditions, then each powder particle contains many fine grains having a nanometer size range, such as, for example, from about 10 nanometers up to about 200 nanometers.

The blended powders are then preferably compacted at a temperature ranging from room temperature (about 20° C.) to about 800° C. to form a bulk isotropic nanocomposite magnet. The compaction step includes loading the powder to be compacted into a die and applying pressure through punches from one or two directions. The compaction can be performed in vacuum, inert atmosphere, or air. This step is illustrated in FIG. 64. If the powder to be compacted is in an amorphous or partial crystallized condition, then the hot compaction is not only a process of consolidation and formation of a bulk material, but also a process of crystallization and formation of nanograin structure.

By “a bulk magnet” we mean that the magnet does not exist in a form of powders, ribbons, or flakes. A bulk magnet typically has a dimension of at least about 2-3 mm. In examples of this invention given below, the nanocomposite magnets have diameters from about 12 to 25 mm.

If the compaction is performed at an elevated temperature, the total hot compaction time, including heating from room temperature to the hot compaction temperature, performing hot compaction, and cooling to around 150° C., is preferably from about 2 to about 10 minutes, typically from about 2 to about 3 minutes. While the hot compaction time, defined as the time maintained at the hot compaction temperature is from 0 to about 5 minutes, typically from 0 to about 1 minute.

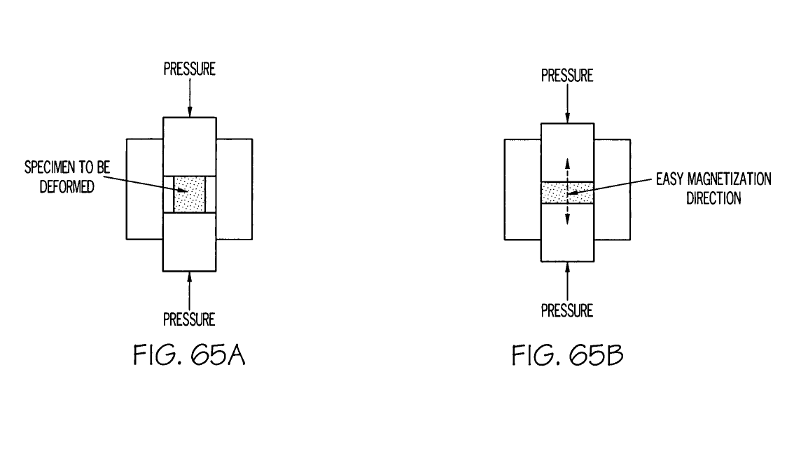

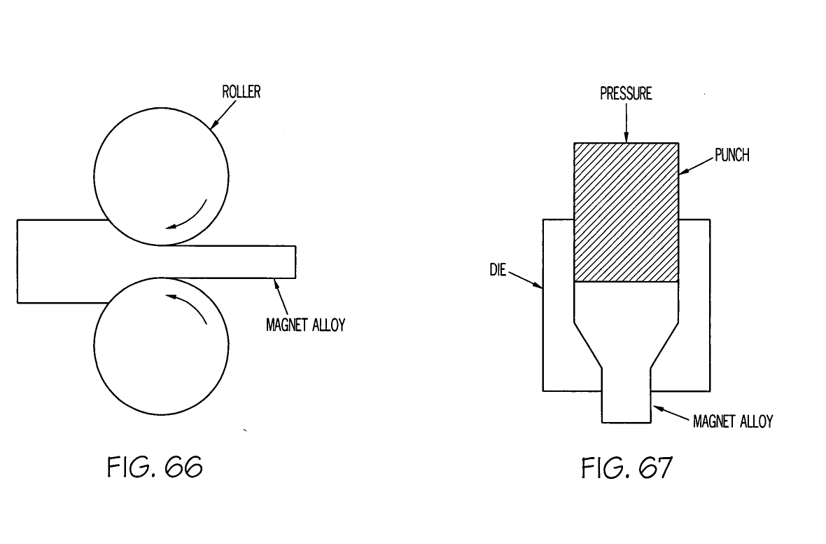

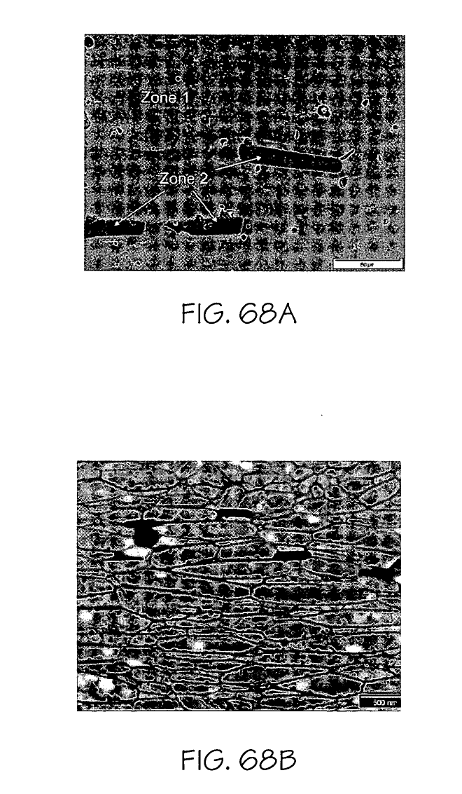

Preferably, the compacted isotropic nanocomposite magnet is further subjected to hot deformation at a temperature from about 700° C. to about 1000° C. to form an anisotropic nanocomposite magnet. The hot deformation step may be performed using a process such as die upsetting, hot rolling, or hot extrusion as shown in FIGS. 65-67. For die upsetting, the specimen is first loaded into a die with a diameter larger than the diameter of the specimen (FIG. 65 (a)), and then pressure is applied so plastic deformation occurs and eventually the cavity is filled (FIG. 65 (b)). The hot deformation can be performed in vacuum, inert atmosphere, or air. The difference between hot compaction and hot deformation lies in the fact that a hot deformation process involves the plastic flow of material, while a hot compaction process is basically a process of consolidation involving little plastic flow of material.

The total hot deformation time, including heating from room temperature to the hot deformation temperature, performing hot deformation, and cooling to around 150° C., is preferably from about 10 to about 30 minutes, typically from about 6 to about 10 minutes. The hot deformation time, defined as the time maintained at the hot deformation temperature is from about 1 to about 10 minutes, typically from about 2 to about 6 minutes.

Both hot compaction and hot deformation can be performed in vacuum, inert gas, reduction gas, or air.

As a special case of this method, the blended powder mixture can be directly hot deformed without compaction. For doing this, the powder is enclosed in a metallic container before hot deformation.

When this method is used to produce bulk anisotropic nanocomposite Nd₂Fe₁₄B/α-Fe or Nd₂Fe₁₄B/Fe—Co magnets, the typical magnetic properties will be as follows: Remanence, Bᵣ≈11-14 kG, Intrinsic coercivity, _{M}H_{C}≈8-12 kOe, and maximum energy product, (BH)ₘₐₓ=25-45 MGOe.

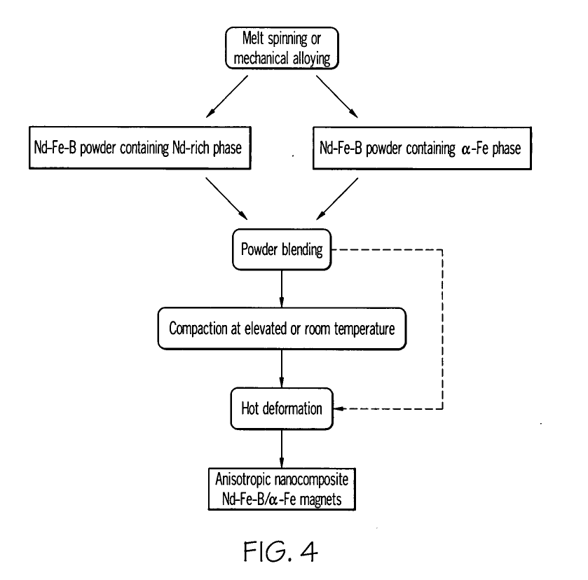

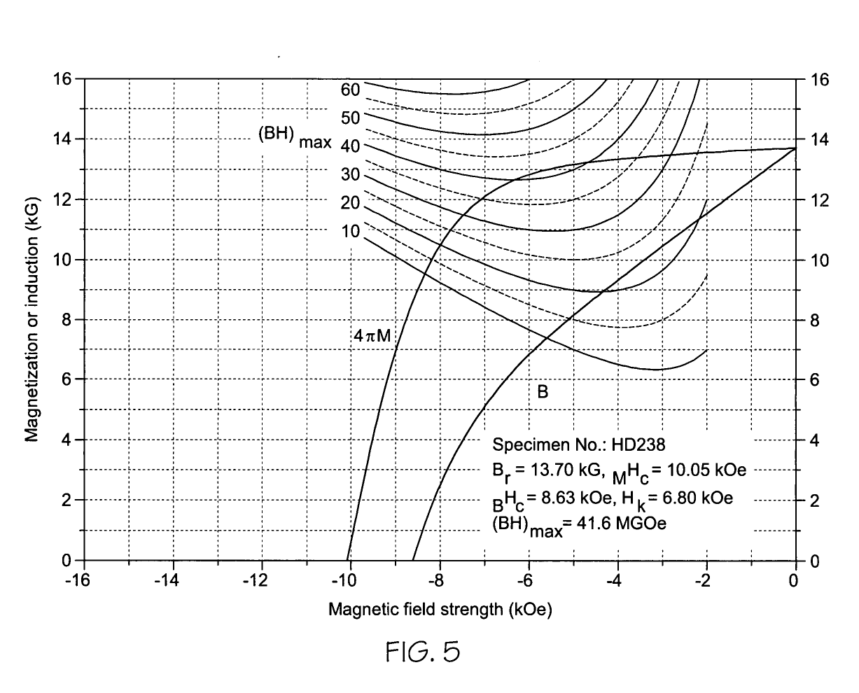

A flowchart of this method is shown in FIG. 4. Examples of nanocomposite magnets synthesized using this method are given in Examples 3-5 and FIGS. 5-7.

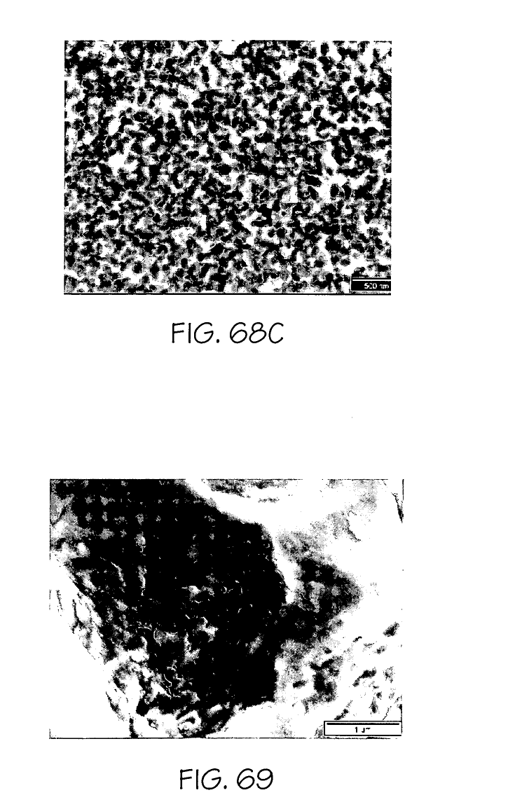

The typical microstructure of a nanocomposite magnet synthesized using this method includes two zones as shown in FIG. 68A. The first zone is formed from the rare earth-transition metal alloy powder that has an effective rare earth content in an amount greater than the stoichiometric composition. Good grain alignment can be created in this zone during hot deformation, as shown in FIG. 68B. In contrast, the second zone is formed from the rare earth-transition metal alloy powder that has an effective rare earth content in an amount less than the stoichiometric composition. Because of the lack of a rare earth-rich phase in this zone, essentially no grain alignment can be created during hot deformation, as shown in FIG. 68C. Thus, the nanocomposite magnet prepared using this method is actually a mixture of an anisotropic part and an isotropic part.

Using this method, the fraction of the magnetically soft phase can be from about 0.5 vol % up to about 20 vol %. The existence of a very small amount of soft phase, such as 0.5-1 vol % of α-Fe in nanocomposite Nd—Fe—B/α-Fe magnets, can lead to slight improvement in remanence and maximum energy product.

Method 2

It can be seen from FIGS. 5, 6, and 7 that by decreasing the Nd content in the Nd-poor alloy powder from 11 at % to 6 at % and further to 4 at %, higher (BH)ₘₐₓ can be achieved. Good grain alignment can be created in the Nd-rich alloy powder during hot deformation, while hot compacting Nd-poor alloy powder followed by hot deformation basically results in isotropic magnets. By reducing the Nd content in the Nd-poor alloy powder, the amount of the Nd-poor alloy powder that has to be used to form a specific nanocomposite magnet will be reduced, thus, leading to a decreased portion that has poor grain alignment in the composite magnet.

If the Nd content in the Nd-poor alloy powder is further reduced from 4 at % to zero, then, the second powder becomes pure α-Fe or Fe—B alloy powder. In this case, the amount of the second alloy powder necessary to form a specific nanocomposite magnet will be reduced to the minimum, and the best magnetic performance will be obtained under the condition that the added α-Fe or Fe—B alloy powder does not deteriorate the crystallographic texture formation during hot deformation.

Reducing the rare earth content to zero in the rare earth-poor alloy powder in the previous embodiment gives rise to the second embodiment of the invention.

In this embodiment, the method comprises blending at least one rare earth-transition metal alloy powder having an effective rare earth content greater than the stoichiometric amount of the corresponding rare earth-transition metal compound with at least one powdered soft magnetic material. In this embodiment, the rare earth-transition metal alloy powder(s) preferably have a particle size from about 1 micrometer to about 1000 micrometers, typically from about 10 to about 500 micrometers, and the soft magnetic material powder(s) have a particle size of about 10 nanometers to about 80 micrometers.

The rare earth-transition metal alloy powders may be prepared by using rapid solidification methods, including but not limited to melt-spinning, spark erosion, plasma spray, and atomization; or by using mechanical alloying or mechanical milling. The powder particles can be either in amorphous or partially crystallized condition, or in crystalline nanograin condition.

The rare earth-transition metal alloy preferably comprises at least one compound with an atomic ratio of R:T or R:T:M selected from 1:5, 1:7, 2:17, 2:14:1, or 1:12. The rare earth-transition metal compound is preferably selected from Nd₂Fe₁₄B, Pr₂Fe₁₄B, PrCo₅, SmCo₅, SmCo₇, and Sm₂Co₁₇.

The soft magnetic material powder is preferably selected from α-Fe, Fe—Co, Fe—B, or other alloys containing Fe, Co, or Ni. The soft magnetic material powder can be in amorphous or crystalline condition. If it is in a crystallized condition, its grain size is preferably under 1 micrometer. In that case, one magnetically soft material particle contains many fine nanograins.

The blended powders are preferably compacted at a temperature ranging from room temperature (about 20° C.) to about 800° C. to form a bulk isotropic nanocomposite magnet. The total hot compaction time, including heating from room temperature to the hot compaction temperature, performing hot compaction, and cooling to around 150° C., is preferably from about 2 to about 10 minutes, typically from about 2 to about 3 minutes. The hot compaction time, defined as the time maintained at the hot compaction temperature is from 0 to about 5 minutes, typically from 0 to about 1 minute.

Preferably, the compacted isotropic nanocomposite magnet is further subjected to hot deformation at a temperature from about 700° C. to about 1000° C. to form a bulk anisotropic nanocomposite magnet. The total hot deformation time, including heating from room temperature to the hot deformation temperature, performing hot deformation, and cooling to around 150° C., is preferably from about 10 to about 30 minutes, typically from about 6 to about 10 minutes. The hot deformation time, defined as the time maintained at the hot deformation temperature, is from about 1 to about 10 minutes, typically from about 2 to about 6 minutes.

Both hot compaction and hot deformation can be performed in vacuum, inert gas, reduction gas, or air.

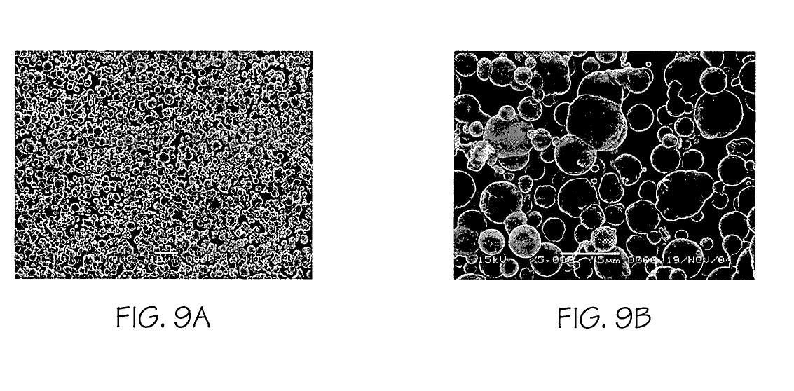

FIG. 8 is a flowchart illustrating the second method using nanocomposite Nd—Fe—B/α-Fe or Nd—Fe—B/Fe—Co as examples. Examples of nanocomposite magnets synthesized using this method are given below in Examples 6-14 and FIGS. 9-36.

Since the rare earth-transition metal alloy powder has a rare earth-rich phase, good grain alignment can be formed during the hot deformation process. Many experimental results established that the added magnetically soft material powder does not deteriorate the texture formation in the hard phase.

The magnetically hard phase in a nanocomposite magnet made using this method can be of micrometer size as a phase; however, its grain size is in nanometer range. Similarly, the magnetically soft phase in the nanocomposite magnet made using this method can be of micrometer size as a phase; however, its grain size is in nanometer range.

As a special case of this method, the blended powder mixture can be directly hot deformed without compaction. For doing this, the powder is enclosed in a metallic container before hot deformation.

When this method is used to produce bulk anisotropic nanocomposite Nd₂Fe₁₄B/α-Fe or Nd₂Fe₁₄B/Fe—Co magnets, the typical magnetic properties will be as follows: Remanence, Bᵣ≈12-15 kG, Intrinsic coercivity, _{M}H_{C}≈8-16 kOe, and maximum energy product, (BH)ₘₐₓ≈30-55 MGOe.

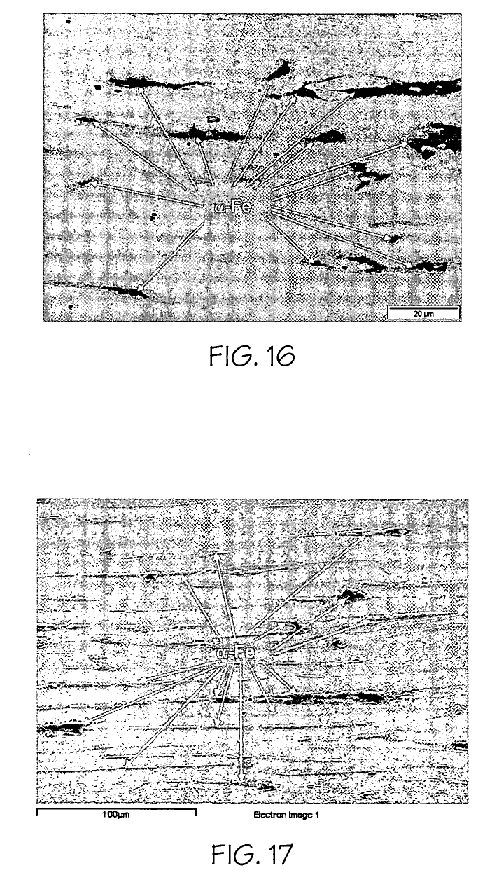

The size of the magnetically soft phase in the nanocomposite magnet prepared using this method can be quite large, e.g., up to 50 micrometers as shown in FIGS. 16, 30, and 31. Some times, the magnetically soft phase can be as layers distributed in the magnetically hard matrix phase, as shown in FIG. 17. Using this method, the fraction of the magnetically soft phase can be from about 0.5 vol % up to about 50 vol %. Even a very small amount of soft phase addition, such as 0.5-1 vol % of α-Fe in nanocomposite Nd—Fe—B/α-Fe magnets, can lead to slight improvement in remanence and maximum energy product.

Method 3

Although the size of the soft phase can be as large as in the micron range, a large size of the soft phase is not necessarily good in a nanocomposite magnet. While not wishing to be bound to one particular theory, it is believed that when the grain size in a permanent magnet (or in the magnetically hard phase in a hard/soft composite magnet) is reduced from conventional micron size to nanometer range, forming multi magnetic domains in a nanograin is no longer energetically favorable. Therefore, the magnetization reversal in a nanograin magnet (or in the nanograin hard phase in a composite magnet) is carried out not through the nucleation and growth of reversed domains or domain wall motion, but through rotation of magnetization. If a magnetically soft phase exists between two hard grains and the grain size of the soft phase is also in nanometer range, the rotation of magnetization will be started from the middle of the soft phase. The exchange coupling interaction between the hard and soft grains at the soft/hard interface tends to restrict the direction of magnetic moments of the soft grain in the direction the same as those in the hard grain, which makes the rotation of magnetization in the hard and soft phase incoherent.

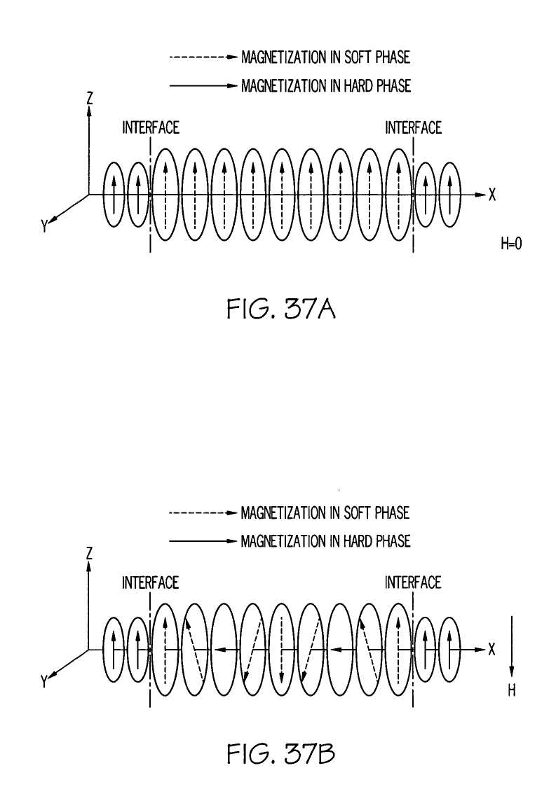

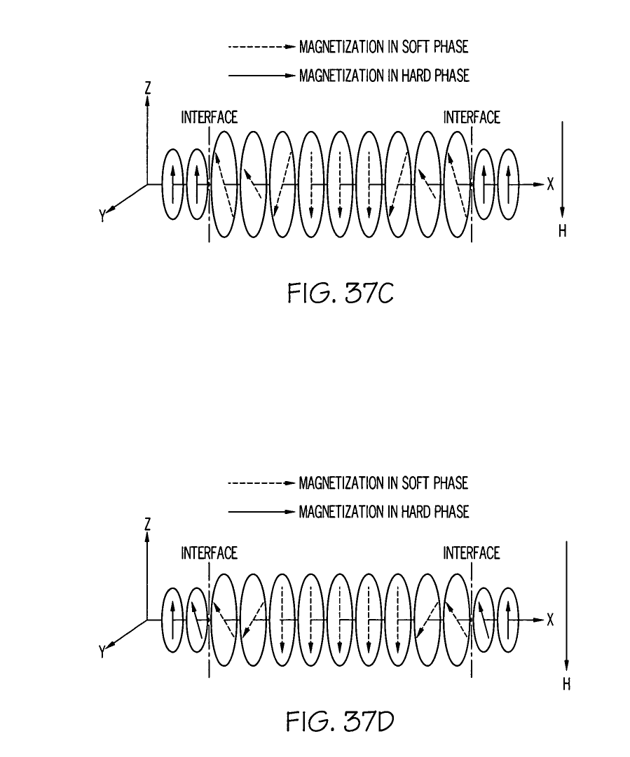

FIG. 37 shows magnetization reversal and hard/soft interface exchange coupling in a composite magnet. When a demagnetization field is applied as shown in FIG. 37(b), the magnetization in the middle of the soft grain will be rotated first, since it has the longest distance from the hard/soft interface, and therefore, has the weakest demagnetization resistance. Reducing the size of the soft grain will reduce the distance from the hard/soft interface to the middle of the soft grain, leading to increased resistance to demagnetization and, hence, enhanced intrinsic coercivity and improved squareness of demagnetization curve.

FIG. 38 shows a schematic illustration of the effect of the size of the soft phase on demagnetization of a hard/soft composite magnet.

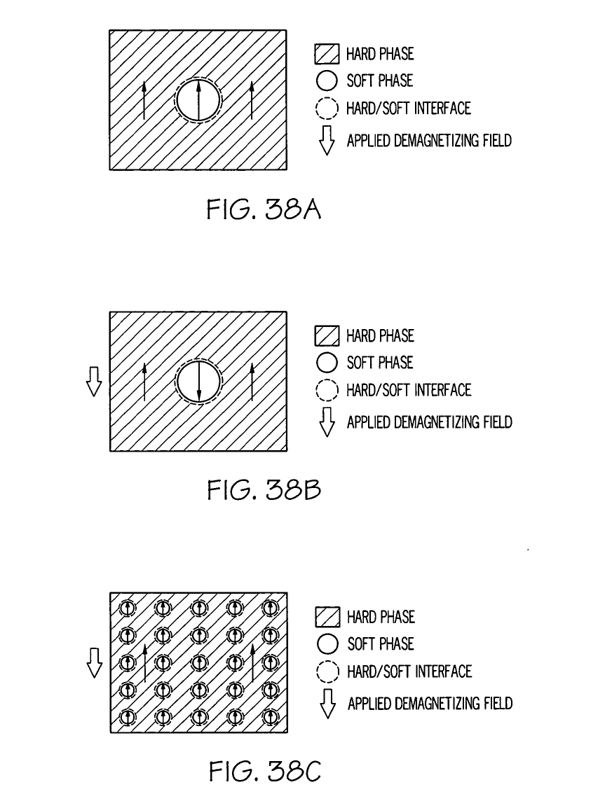

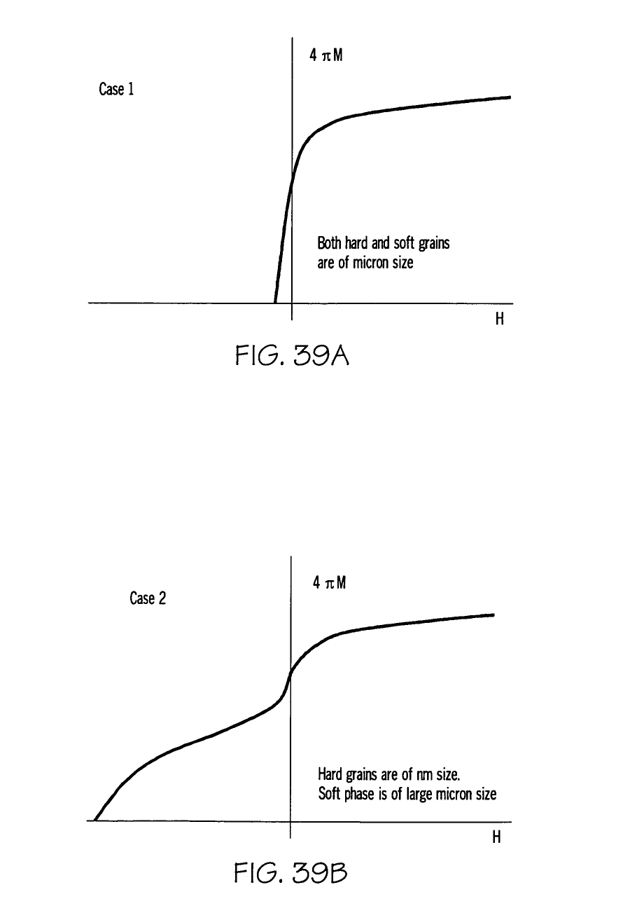

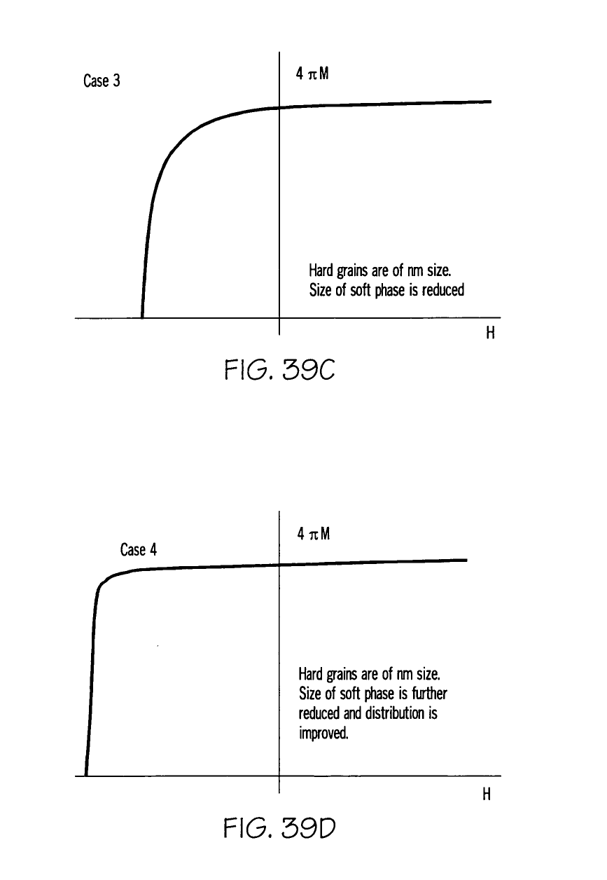

FIG. 39 shows the effect of the size of the hard grains and soft phase on demagnetization of composite magnets, such as Nd₂Fe₁₄B/α-Fe and Sm₂Co₁₇/Co.

If the particle size of α-Fe and Fe—Co powders that are used to make composite magnets can be significantly reduced and a more disperse distribution can be made, then the magnetic performance of nanocomposite magnets can be significantly improved.

The saturation magnetization and, hence, the potential Br and (BH)max, of a nanocomposite magnet is dependent on the volume fraction of the soft phase in the composite magnet. Adding more soft phase will lead to higher saturation magnetization, which, on the other hand, will result in decreased coercivity. However, the drop of coercivity can be minimized by decreasing the size and improving the distribution of the soft phase. This concept can be illustrated in the following equations.
(4 πMₛ)_{comp}=(4 πMₛ)_{hard}(1−V_{soft})+(4 πMₛ)_{soft}V_{soft} (1)
(_{M}H_{C})_{comp}=k(1−1/p)(_{M}H_{C})_{hard} (2)
(Hₖ/_{M}H_{C})_{comp}=k(1−1/p)(Hₖ/_{M}H_{c})_{hard} (3)
where v_{soft} is the volume fraction of the soft phase
p=(S/V)_{soft} and S and V are the surface area and volume of the soft phase, respectively. p will be doubled when the diameter is reduced to one-half while maintaining the original volume.
k is a constant related to v_{soft} and k≦1.

In above equations, ρ=(S/V)_{soft}, defined as the soft phase disperse factor, describes the distribution of the soft phase in a composite magnet where S is the total surface area, while V is the total volume of the soft phase. A large ρ value represents more dispersed distribution of the soft phase, leading to more effective interface exchange coupling between the hard and soft phases. On the other hand, with more dispersed soft phase distribution, more soft phase can be added into the nanocomposite magnet, leading to higher magnetic performance.

The above consideration leads to an alternative method that is to coat the Nd-rich Nd—Fe—B powder particles with thin α-Fe or Fe—Co layers, which gives rise of the third embodiment.

In this embodiment, the method comprises coating powder particles of at least one rare earth-transition metal alloy that has an effective rare earth content in an amount greater than the stoichiometric amount of the corresponding rare earth-transition metal compound with a soft magnetic material alloy layer or layers.

The rare earth-transition metal alloy preferably comprises at least one compound with an atomic ratio of R:T or R:T:M selected from 1:5, 1:7, 2:17, 2:14:1, or 1:12. The rare earth-transition metal compound is preferably selected from Nd₂Fe₁₄B, Pr₂Fe₁₄B, PrCo₅, SmCo₅, SmCo₇, and Sm₂Co₁₇. The soft magnetic material is preferably selected from α-Fe, Fe—Co, Fe—B, or other alloys containing Fe, Co, or Ni.

The rare earth-transition metal alloy powders may be prepared by using rapid solidification methods, including but not limited to melt-spinning, spark erosion, plasma spray, and atomization; or by using mechanical alloying or mechanical milling. The powder particles are either amorphous, partially crystallized, or in crystalline nanograin condition.

In this embodiment, the rare earth-transition metal alloy powder or powders generally have a particle size from about 1 micrometer to about 1000 micrometers, typically from about 10 to about 500 micrometers, while the soft magnetic metal or alloy layer or layers preferably have a thickness of about 10 nanometers to about 10 micrometers.

The rare earth-transition metal alloy powder particles are preferably coated with soft magnetic material by a method including, but not limited to, chemical coating (electroless deposition), electrical coating, chemical vapor deposition, a sol-gel process, or physical vapor deposition, such as sputtering, pulsed laser deposition, thermal evaporation deposition, or e-beam deposition.

The coated powder(s) are then preferably compacted at a temperature ranging from room temperature (about 20° C.) to about 800° C. to form a bulk isotropic nanocomposite magnet. The total hot compaction time, including heating from room temperature to the hot compaction temperature, performing hot compaction, and cooling to around 150° C., is preferably from about 2 to about 10 minutes, typically from about 2 to about 3 minutes. The hot compaction time, defined as the time maintained at the hot compaction temperature, is from 0 to about 5 minutes, typically from 0 to about 1 minute.

Preferably, the compacted isotropic nanocomposite magnet is further subjected to hot deformation at a temperature from about 700° C. to about 1 000° C. to form a bulk anisotropic nanocomposite magnet. The total hot deformation time, including heating from room temperature to the hot deformation temperature, performing hot deformation, and cooling to around 150° C., is preferably from about 10 to about 30 minutes, typically from about 6 to about 10 minutes. The hot deformation time, defined as the time maintained at the hot deformation temperature, is from about 1 to about 10 minutes, typically from about 2 to about 6 minutes.

Both hot compaction and hot deformation can be performed in vacuum, inert gas, reduction gas, or air.

Experimental data showed that when making Nd—Fe—B/α-Fe or Nd—Fe—B/Fe—Co nanocomposite magnets by using this method, the coated thin α-Fe or Fe—Co layer actually plays a role of improving grain alignment in the hard phase as shown in Table 1.

TABLE 1
Comparison of grain alignment represented by Hₖ/_{M}H_{c} and 4ΠM
at (BH)ₘₐₓ/(4ΠM)ₘₐₓ.

| | Hₖ/_{M}H_{c} | 4ΠM at (BH)ₘₐₓ/ | |
|---|---|---|---|
| Materials | (%) | (4ΠM)ₘₐₓ (%) | Note |
| Hot compacted and hot | 96.0 | 85.4 | Average of |
| deformed Nd—Fe—B with | | | 10 specimens |
| commercial composition | | | |
| (without soft phase) | | | |
| Nanocomposite Nd—Fe— | 93.7 | 78.8 | Average of |
| B/α—Fe synthesized by | | | 10 specimens |
| blending with α—Fe | | | |
| powder | | | |
| Nanocomposite Nd—Fe— | 96.7 | 88.5 | Average of |
| B/α—Fe synthesized by | | | 10 specimens |
| sputtering | | | |
| Nanocomposite Nd—Fe— | 97.7 | 89.1 | Average of |
| B/α—Fe synthesized by | | | 10 specimens |
| chemical coating | | | |

FIG. 40 is a flowchart illustrating the third embodiment of the invention using composite Nd—Fe—B/α-Fe or Nd—Fe—B/Fe—Co as examples. FIG. 41 is a schematic illustration of a micrometer-sized particle containing many nanometer-sized grains coated with an α-Fe or Fe—Co layer. Using this method, Nd—Fe—B particles can be coated with a thin layer, which results in a better distribution of the soft phase and, hence, better magnetic performance in the resulting nanocomposite magnets.

As a special case of this method, the blended powder mixture can be directly hot deformed without compaction. For doing this, the powder is enclosed in a metallic container before hot deformation.

When this method is used to produce bulk anisotropic nanocomposite Nd₂Fe₁₄B/α-Fe or Nd₂Fe₁₄B/Fe—Co magnets, typical magnetic properties will be in ranges as follows: Remanence, Bᵣ≈13−16 kG, Intrinsic coercivity, _{M}H_{C}≈10−18 kOe, and maximum energy product, (BH)ₘₐₓ≈40−60 MGOe. With further improving processing, reaching (BH)ₘₐₓ over 60-70 MGOe is possible.

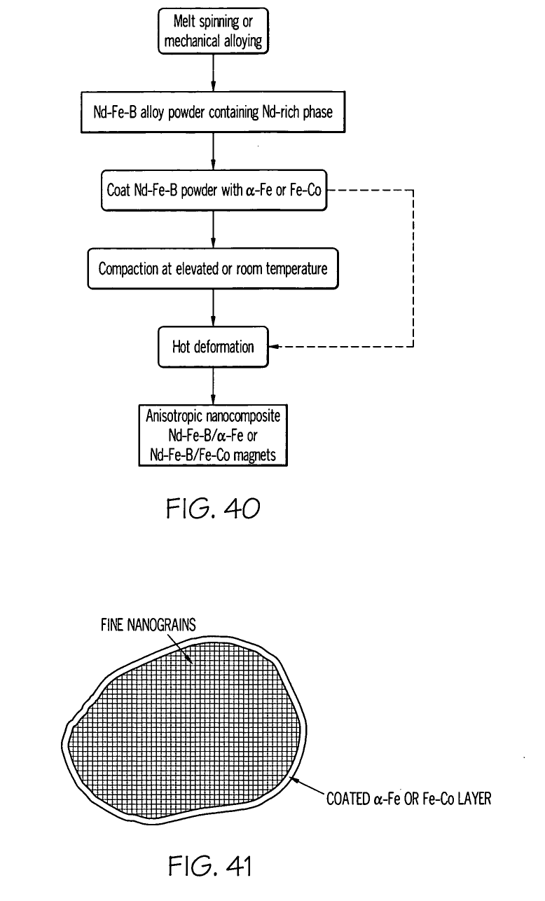

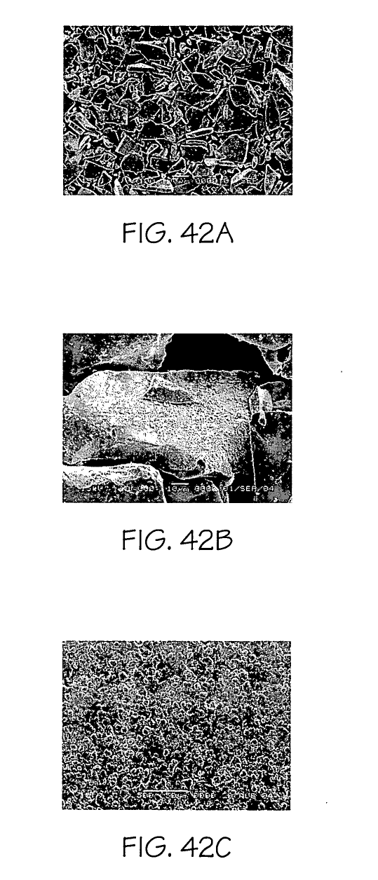

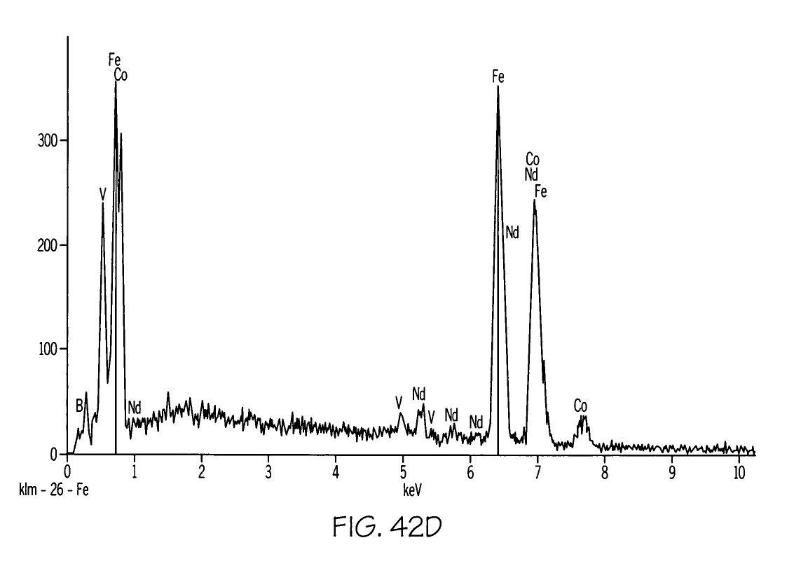

Examples of nanocomposite magnets synthesized using this method are given below in Examples 15-19 and FIGS. 42-57.

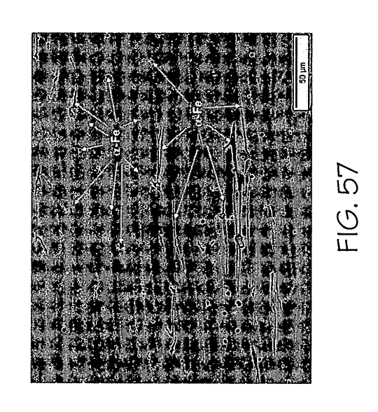

The nanocomposite magnet prepared using this method shows the magnetically soft phase distributed as layers in the magnetically hard matrix phase as shown in FIG. 57. Using this method, the fraction of the magnetically soft phase can be from about 0.5 vol % up to about 50 vol %. Even a very thin coating layer of soft phase, such as 0.5- 1 vol % of α-Fe in nanocomposite Nd—Fe—B/α-Fe magnets, can lead to slight improvement in remanence and maximum energy product.

It should be appreciated that the overall rare earth content in the nanocomposite rare earth magnet synthesized using the above three methods can be either less than, or equal to, or greater than the stoichiometric amount. For example, in the nanocomposite Nd—Fe—B/α-Fe magnets, the Nd content can be either less than, or equal to, or greater than 11.76 at %. In addition to the main Nd₂Fe₁₄B phase, both a minor Nd-rich phase and an α-Fe phase can exist simultaneously in the magnet. Thus, the nanocomposite magnets synthesized using above-mentioned methods can be in a chemical non-equilibrium condition.

FIG. 58 shows the theoretical (BH)ₘₐₓ vs. Nd content and a Nd range in nanocomposite Nd—Fe—B/α-Fe magnets in a chemically non-equilibrium (metastable) condition.

During the elevated temperature processing, such as hot compaction, especially hot deformation, diffusion may occur between the rare earth-rich phase and the magnetically soft phase. In the case of Nd—Fe—B/α-Fe, the diffusion leads to formation of a NdFe₂ phase, or Nd₂Fe₁₄B phase if extra B is available, which would be ideal since Nd₂Fe₁₄B has much better hard magnetic properties than NdFe₂. If the rare earth-transition metal alloy powder contains only a small amount of rare earth-rich phase, then, in a final nanocomposite magnet after hot deformation, there may exist only a magnetically soft phase without any rare earth-rich phase.

Method 4

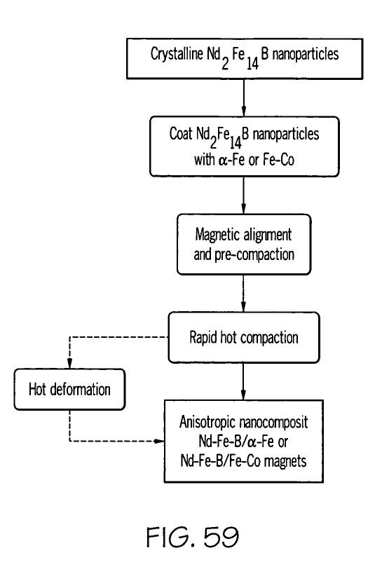

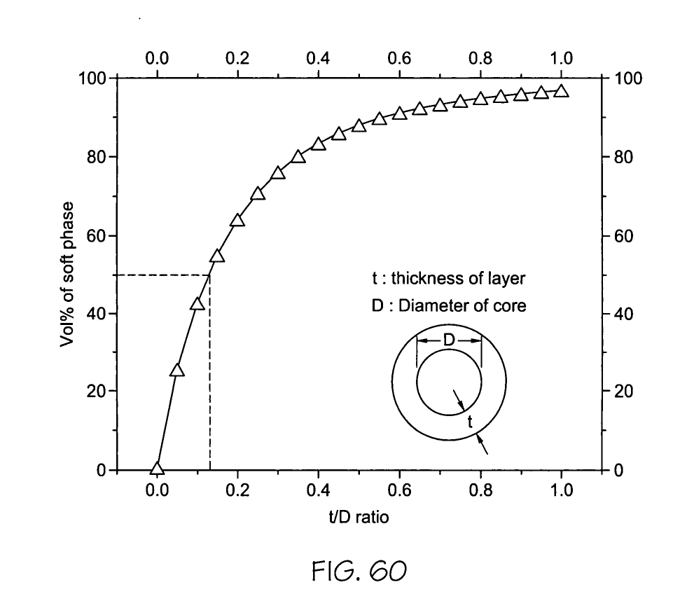

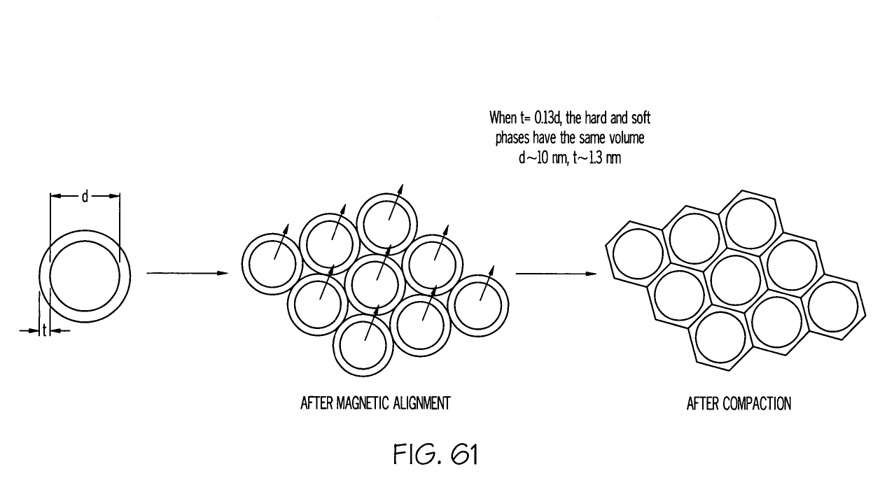

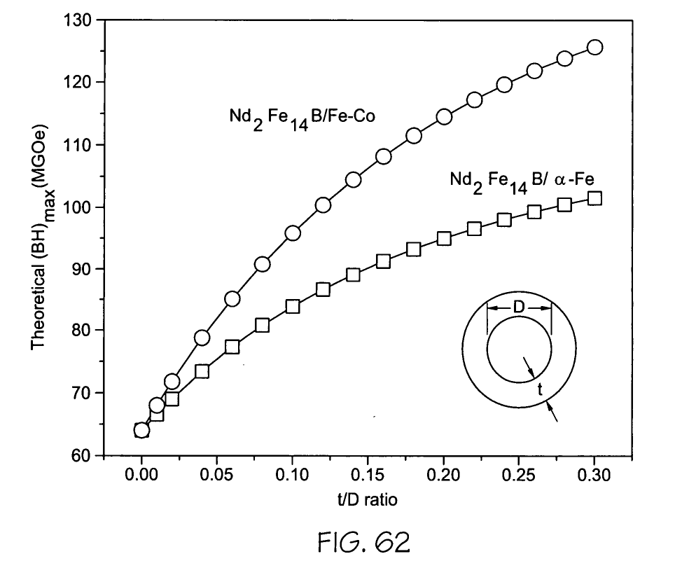

Decreasing the particle size of the rare earth-transition metal alloy powder to be coated leads to more dispersed distribution of the magnetically soft phase in the nanocomposite magnet and, hence, improved magnetic performance. When the particle size of the rare earth-transition metal alloy powder to be coated is reduced to a nanometer range, it is possible to utilize a magnetically hard core nanoparticle coated with a magnetic soft shell structure, which can effectively increase the volume fraction of the soft phase without significantly increasing the dimension of the soft phase. A flowchart of this fourth method of making nanocomposite magnets is shown in FIG. 59. FIG. 60 shows the volume fraction of the soft shell phase vs. the ratio of the shell thickness to the core diameter. FIG. 61 schematically shows the process of synthesizing nanocomposite magnets composed of soft shell/hard core particles. FIG. 62 illustrates the theoretical (BH)max in nanocomposite Nd₂Fe₁₄B/α-Fe and Nd₂Fe₁₄B/Fe—Co magnets with soft shell/hard core nanocomposite structure.

Accordingly, in the fourth embodiment of the invention, the method comprises coating nanocrystalline particles of at least one rare earth-transition metal compound that has a composition close or equal to the stoichiometric composition with a soft magnetic metal or alloy layer or layers.

The particle size of the rare earth-transition metal nanoparticles is from about a few nanometers to a few hundred nanometers, while the coated soft magnetic metal or alloy layer or layers preferably have a thickness of about 5% to about 30% of the nanoparticle diameter.

The rare earth-transition metal nanoparticles can have an atomic ratio of R:T or R:T:M selected from 1:5, 1:7, 2:17, 2:14:1, or 1:12. The rare earth-transition metal nanoparticles are preferably selected from Nd₂Fe₁₄B, Pr₂Fe₁₄B, PrCo₅, SmCo₅, SmCo₇, and Sm₂Co₁₇. The magnetically soft metal or alloy layer material is preferably selected from α-Fe, Fe—Co, Fe—B, or other alloys containing Fe, Co, or Ni.

The rare earth-transition metal nanoparticles are preferably coated with magnetically soft material by using a method including, but not limited to, chemical coating (electroless deposition), electrical coating, chemical vapor deposition, a sol-gel process, or physical vapor deposition, such as sputtering, pulse laser deposition, thermal evaporation deposition, or e-beam deposition.

Since each nanocrystalline particle Is a single crystal, the coated nanoparticle powder can be magnetically aligned in a strong DC or pulse magnetic field before or during a compaction. Subsequent rapid hot compaction at a temperature from about 500° C. to about 900° C. can further increase the density of the compact to full density and results in a bulk anisotropic nanocomposite magnet such as Nd₂Fe₁₄B/α-Fe and Nd₂Fe₁₄B/Fe—Co. An optional hot deformation at a temperature from about 700° C. to about 1000° C. may also be performed after the hot compaction to further improve the grain alignment.

Nanocomposite magnets prepared using method 3 have a larger ρ=(S/V)_{soft} value than those prepared using method 2. The ρ value can reach the maximum in nanocomposite magnets prepared using method 4. As shown in FIG. 60, when the thickness of the soft shell is 13% of the diameter of the hard core, the soft phase fraction will be 50%. Under this condition, if α-Fe and Nd₂Fe₁₄B are used as the hard and soft phases, the saturation magnetization will be 18.75 kG, and the achievable (BH)ₘₐₓ can be 80 MGOe. If Fe—Co is used as the soft phase, the saturation magnetization will be 20.25 kG, and the achievable (BH)ₘₐₓ can be 90 MGOe.

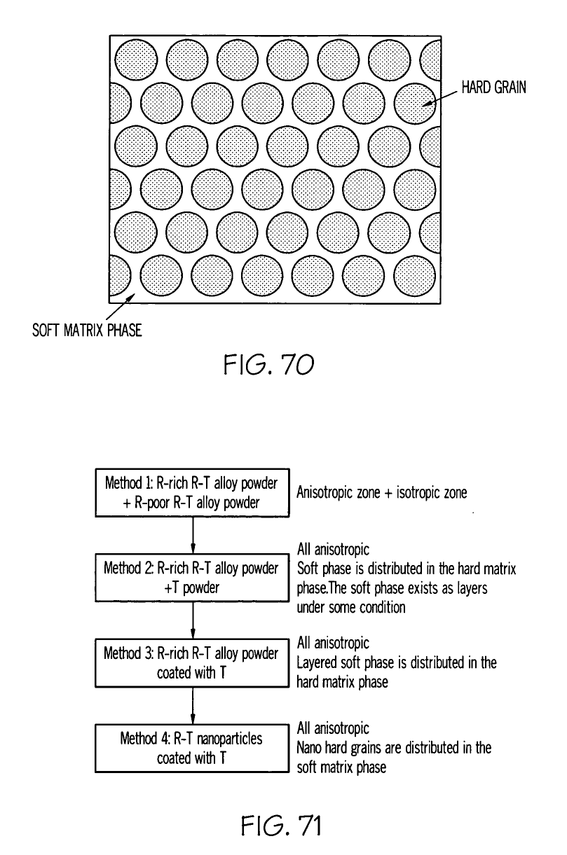

A nanocomposite magnet prepared using this method shows nanometer sized magnetically hard grains embedded in a magnetically soft matrix phase as schematically shown in FIG. 70. Using this method, the fraction of the magnetically soft phase can be from about 10 vol % (when the coating layer thickness is 2% of the nanoparticle diameter) up to about 80 vol % (when the coating layer thickness is 36% of the nanoparticle diameter).

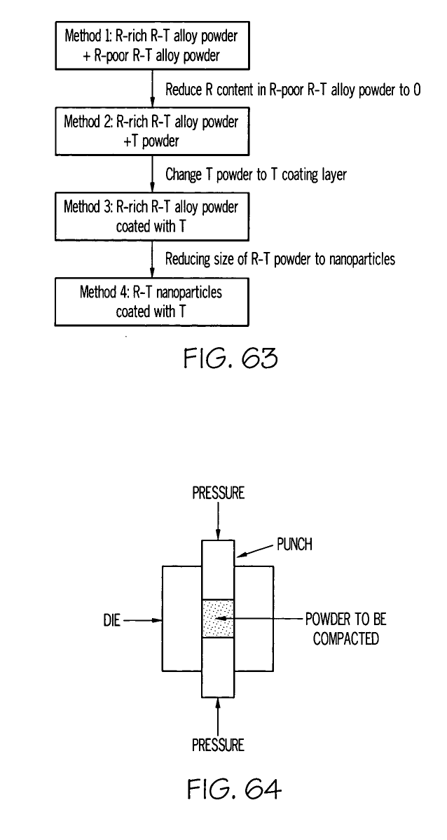

The four methods of synthesizing bulk anisotropic nanocomposite magnets are closely related. FIG. 63 shows the relationship among them. FIG. 71 shows the structure characteristics for the anisotropic magnets made using the four methods.

As mentioned previously, the size and distribution of the magnetically soft phase in a nanocomposite magnet strongly affect intrinsic coercivity and the demagnetization curve squareness. However, it is not possible to control the size and distribution of the magnetically soft phase directly by any previous available technologies. On this aspect, using indirect techniques, such as adjusting the wheel speed during melt spinning, changing milling time during mechanical alloying, or substituting other transition metals for Fe in Nd—Fe—B magnets, only leads to very limited effect. This is because, in all previous nanocomposite rare earth magnet materials as well as nanocomposite magnets prepared using the first method of this invention as described previously, the magnetically soft phase is formed in a metallurgical process, such as by crystallization of a liquid phase, crystallization of an amorphous phase, or precipitation from a matrix phase. In all these processes, no approaches are available for directly controlling the size and distribution of the magnetically soft phase.

In contrast, when using methods 2, 3, and 4 of this invention, the magnetically soft phase is added into the magnetically hard phase by a controllable process, such as by blending powder particles of magnetically soft metal or alloy, or coating with a layer or layers of magnetically soft metal or alloy. Using these controllable processes makes it possible not only to control the size and distribution of the magnetically soft phase directly, but also to control the hard/soft interface directly.

It should be appreciated that the rare earth element in all of the rare earth-transition metal alloys described in the above embodiments may be substituted with other rare earth elements, mischmetal, yttrium, scandium, or combinations thereof. The transition metal element can be substituted with other transition metals or combinations thereof; and elements from Groups IIIA, IVA, and VA, such as B, Al, Ga, Si, Ge, and Sb, can also be added.

Anisotropic Powders and Bonded Magnets

It should be appreciated that bulk anisotropic nanocomposite rare earth magnets made in accordance with the present invention can be crushed into anisotropic nanocomposite magnet powders. The powders can be further blended with a binder to make bonded anisotropic nanocomposite rare earth magnets. Such bonded anisotropic magnets exhibit better thermal stability in comparison with bonded anisotropic magnets made by using anisotropic powders prepared using a hydrogenation, disproportionation, desorption, recombination (HDDR) process.

In order that the invention may be more readily understood, reference is made to the following examples which are intended to illustrate embodiments of the invention, but not limit the scope thereof.

### EXAMPLE 1

A Nd_{10.8}Pr_{0.6}Dy_{0.2}Fe_{76.1}Co_{6.3}Ga_{0.2}Al_{0.2}B_{5.6} magnet was synthesized using a single alloy powder and then hot compacted at 630° C. for a total of around 2 minutes under 25 kpsi and hot deformed at 920° C. for 28 minutes under around 10 kpsi with 60% height reduction. FIG. 2 illustrates the demagnetization curves of the hot deformed magnet. As can be seen, the magnetic performance of the magnet is poor as a result of the poor grain alignment.

### EXAMPLE 2

A Nd₅Pr₅Dy₁Fe₇₃Co₆B₁₀ magnet was synthesized using a single alloy powder and then hot compacted at 680° C. for a total of around 2 minutes under 25 kpsi and hot deformed at 880° C. for 40 minutes under around 10 kpsi with 50% height reduction. FIG. 3 illustrates the demagnetization curves of the hot deformed magnet. As can be seen, the magnetic performance of the magnet is poor as a result of the poor grain alignment.

### EXAMPLE 3

A Nd_{10.8}Pr_{0.6}Dy_{0.2}Fe_{76.1}Co_{6.3}Ga_{0.2}Al_{0.2}B_{5.6} magnet was synthesized using a first alloy powder having a rare earth content of 13.5 at % and a second alloy powder having a rare earth content of 11 at %. The blended powders were hot compacted at 650° C. under 25 kpsi and hot deformed at 880° C. for 6 minutes under 10 kpsi with 63% height reduction. FIG. 5 illustrates the demagnetization curves of the hot compacted and hot deformed magnet.

### EXAMPLE 4

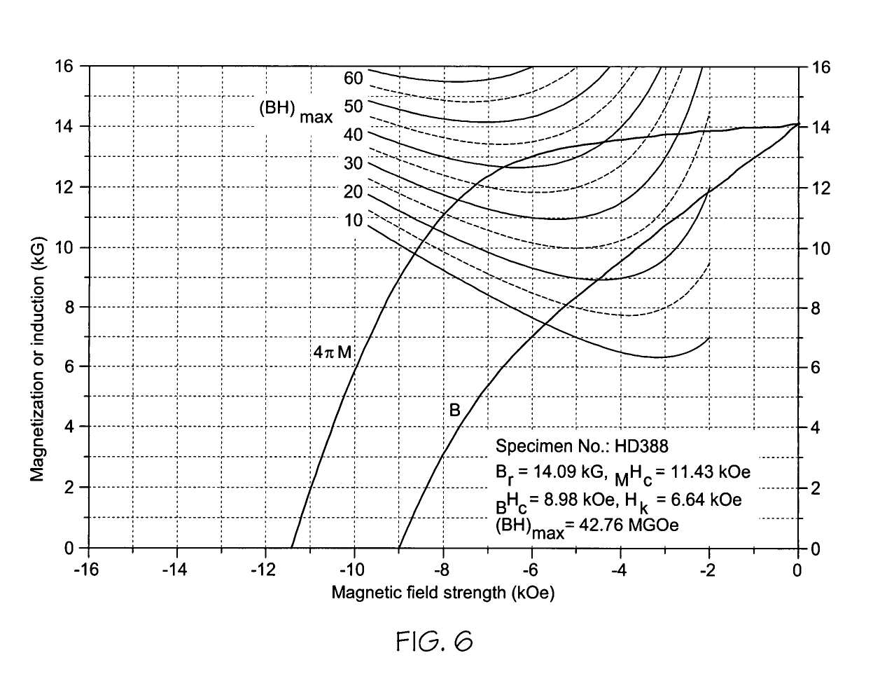

A Nd_{10.8}Pr_{0.6}Dy_{0.2}Fe_{76.1}Co_{6.3}Ga_{0.2}Al_{0.2}B_{5.6} magnet was synthesized using a first alloy powder having a rare earth content of 13.5 at % and a second alloy powder having a rare earth content of 6 at %. The blended powders were hot compacted at 620° C. under 25 kpsi and hot deformed at 940° C. for 2.5 minutes under 10 kpsi with 67% height reduction. FIG. 6 illustrates the demagnetization curves of the hot compacted and hot deformed magnet.

### EXAMPLE 5

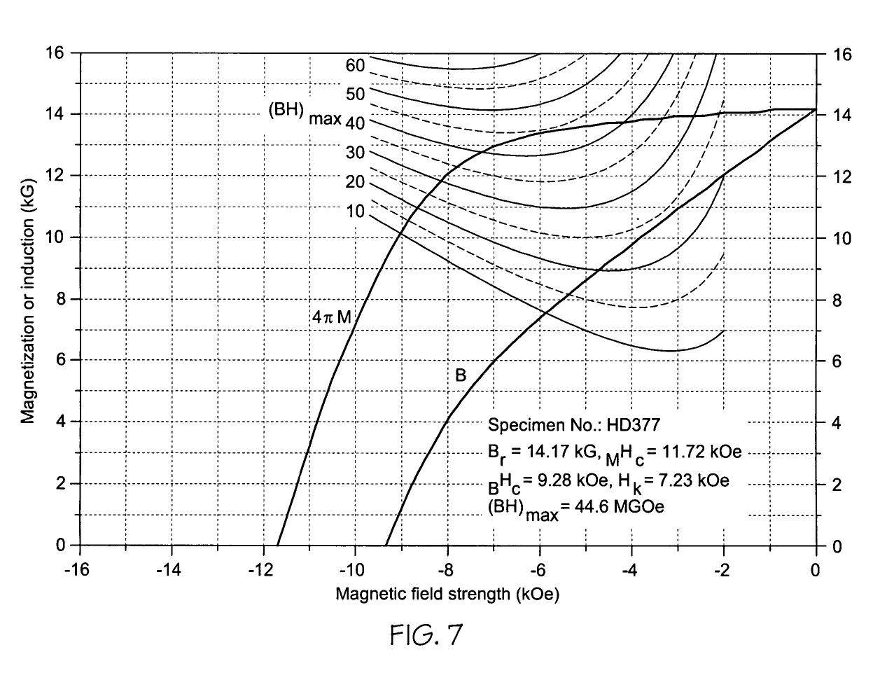

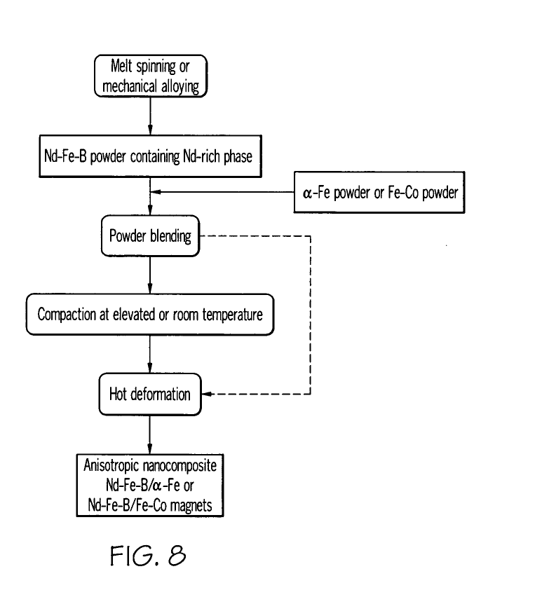

A Nd_{10.8}Pr_{0.6}Dy_{0.2}Fe_{76.1}Co_{6.3}Ga_{0.2}Al_{0.2}B_{5.6} magnet was synthesized using a first alloy powder having a rare earth content of 13.5 at % and a second alloy powder having a rare earth content of 4 at %. The blended powders were hot compacted at 620° C. under 25 kpsi and hot deformed at 910° C. for 2.5 minutes under 4 kpsi with 67% height reduction. FIG. 7 illustrates the demagnetization curves of the hot compacted and hot deformed magnet. It can be seen from FIGS. 5, 6 and 7 that high magnetic performance can be obtained when blending a powder having an Nd content greater than 11.76 at % with a powder having an Nd content less than 11.76 at %.

### EXAMPLE 6

FIG. 9 shows SEM micrographs of α-Fe powder particles used in making nanocomposite Nd—Fe—B/α-Fe magnets in this invention. The average particle size of the α-Fe powder is about 3-4 microns. This α-Fe powder has a relatively high oxygen content of 0.2 wt %. As a comparison, the Nd—Fe—B powder used has a very low oxygen content of only 0.04-0.06 wt %.

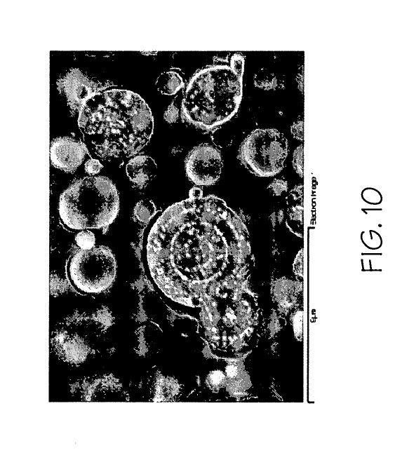

FIG. 10 is an SEM micrograph showing the cross section of the α-Fe powder used in making nanocomposite Nd—Fe—B/α-Fe magnets in this invention. Small grains in the nanometer range and large grains close to 1 micron can be observed from the cross section of the α-Fe powder particles. In addition, a carbide phase (light gray) can be also observed.

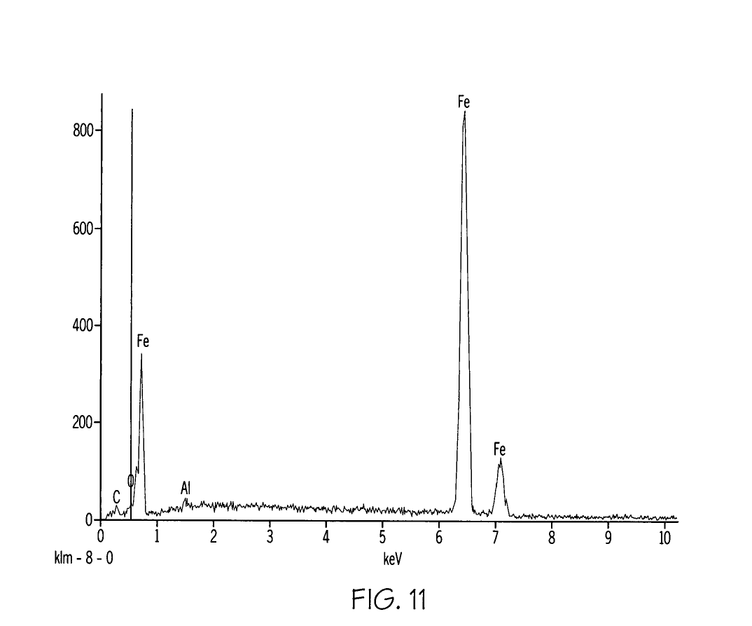

FIG. 11 shows the result of SEM/EDS analysis of ═-Fe powder used in making nanocomposite Nd-13 Fe—B/α-Fe magnets in this invention. Apparently, the powder is basically pure Fe with small amount of impurities, such as C, O, and Al.

FIG. 12 shows the X-ray diffraction pattern of the non-aligned powder crushed from a hot compacted and hot deformed magnet synthesized using Nd_{13.5}Fe₈₀Ga_{0.5}B₆ blended with 8.3 wt % α-Fe powder. The magnet is denoted as Nd_{13.5}Fe₈₀Ga_{0.5}B₆/α-Fe [91.7 wt %/8.3 wt %]. The peak of α-Fe phase can be identified from the XRD pattern.

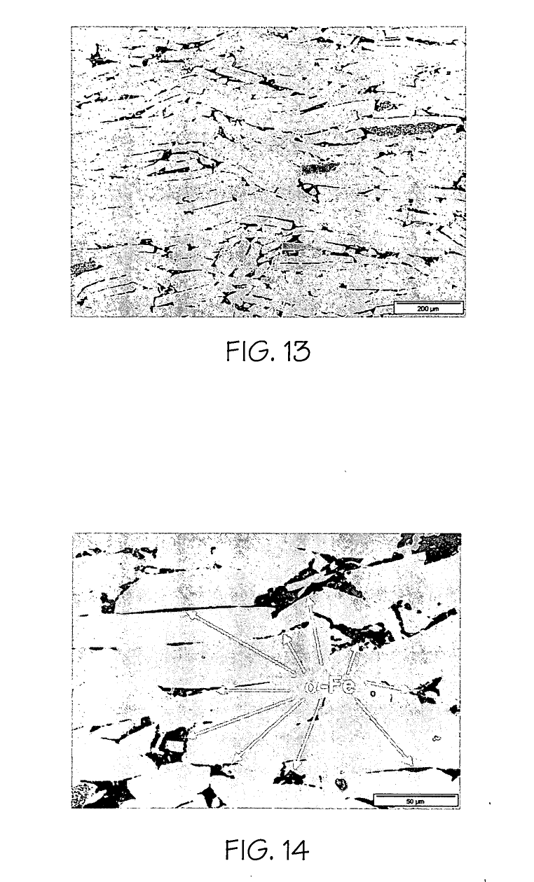

FIG. 13 shows an SEM Micrograph of a hot compacted Nd_{13.5}Fe₈₀Ga_{0.5}B₆/α-Fe [91.7 wt %/8.3 wt %] magnet showing Nd—Fe—B ribbons and the α-Fe phase. The magnet was synthesized using an alloy powder with Nd=13.5 at % blended with 8.3 wt % α-Fe powder. The hot compaction was performed at 620° C. for 2 minutes under 25 kpsi.

FIG. 14 shows an SEM Micrograph of the same magnet as shown in FIG. 13, but with larger magnification. Large α-Fe phase with 10-30 micrometers can be seen.

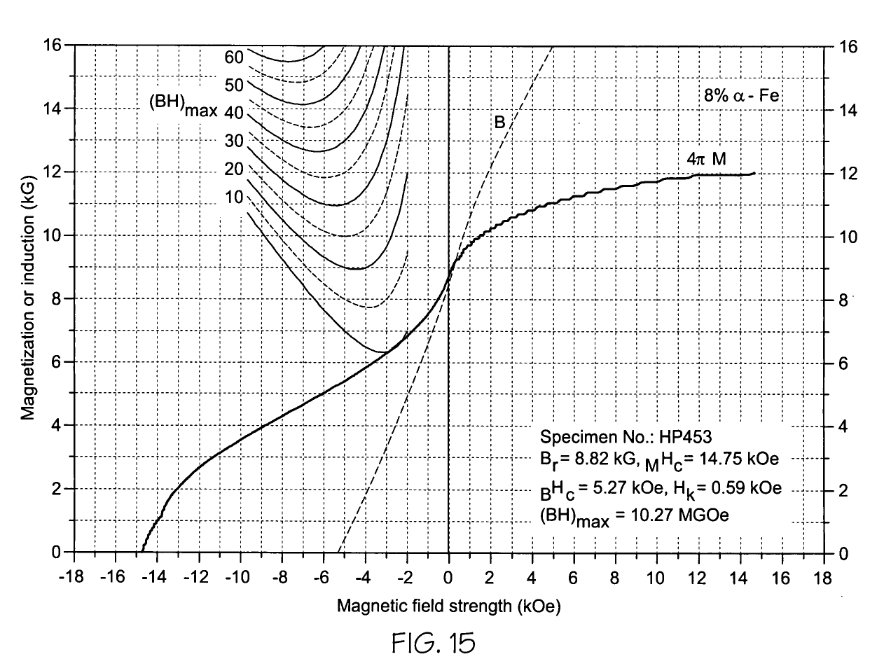

FIG. 15 shows the demagnetization curves of a hot compacted Nd_{13.5}Fe₈₀Ga_{0.5}B₆/α-Fe [92 wt %/8 wt %] magnet showing a kinked 2^{nd} quadrant demagnetization curve, indicating non-effective interface exchange coupling between the hard and soft phases. The hot compaction was performed at 620° C. for 2 minutes under 25 kpsi.

### EXAMPLE 7

Hot deforming the hot compacted isotropic nanocomposite Nd—Fe—B/α-Fe magnets prepared by blending a Nd-rich Nd—Fe—B alloy powder and a α-Fe powder leads to reduced size and improved distribution of the α-Fe phase.

FIG. 16 shows an SEM back scattered electron image of a hot deformed Nd_{13.5}Fe₈₀Ga_{0.5}B₆/α-Fe [91.7 wt %/8.3 wt %] magnet. The dark phase is α-Fe. The hot deformation was deformed at 940° C. for 4 minutes with height reduction of 67%. The size of the α-Fe phase is slightly reduced after hot deformation.

FIG. 17 shows an SEM second electron image of a hot deformed Nd₁₄Fe_{79.5}Ga_{0.5}B₆/α-Fe [92 wt %/8 wt %]. The hot deformation was performed at 900° C. for 5 minutes with height reduction of 70%. The distribution of the α-Fe phase is improved after hot deformation by forming layered α-Fe phase.

### EXAMPLE 8

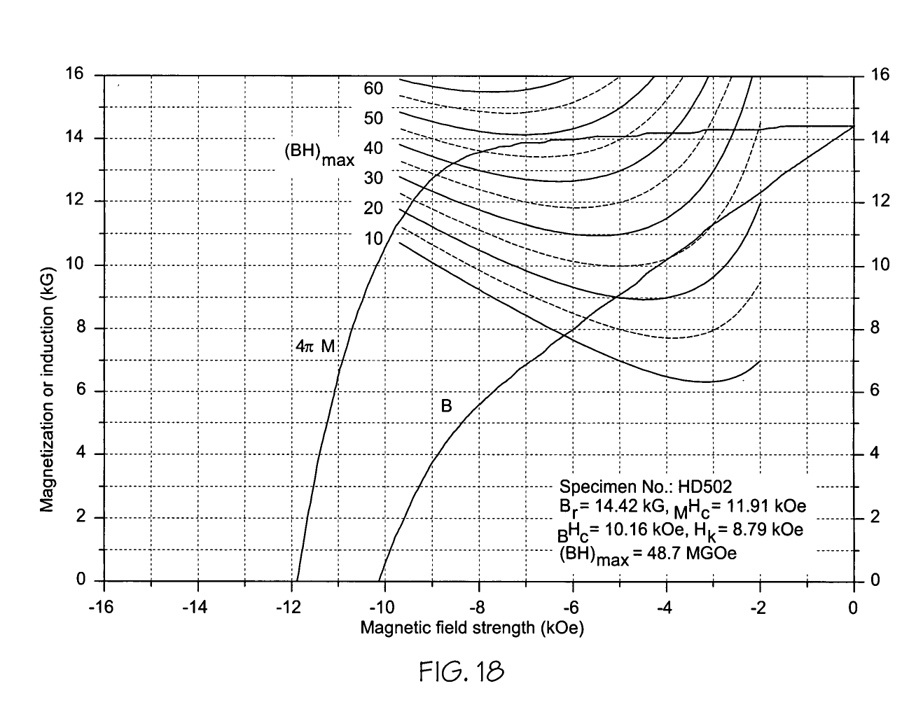

FIG. 18 shows the demagnetization curves of a hot compacted and hot deformed Nd_{13.5}Fe₈₀Ga_{0.5}B₆/α-Fe [98 wt %/2 wt %] magnet synthesized using a Nd—Fe—Ga—B alloy powder having a Nd content of 13.5 at % blended with 2 wt % α-Fe powder. The hot compaction was performed at 600° C. for 2 minutes and the hot deformation was performed at 880° C. for 4 minutes with height reduction of 68%. The smooth demagnetization curve as shown in FIG. 18 indicates effective hard/soft interface exchange coupling.

### EXAMPLE 9

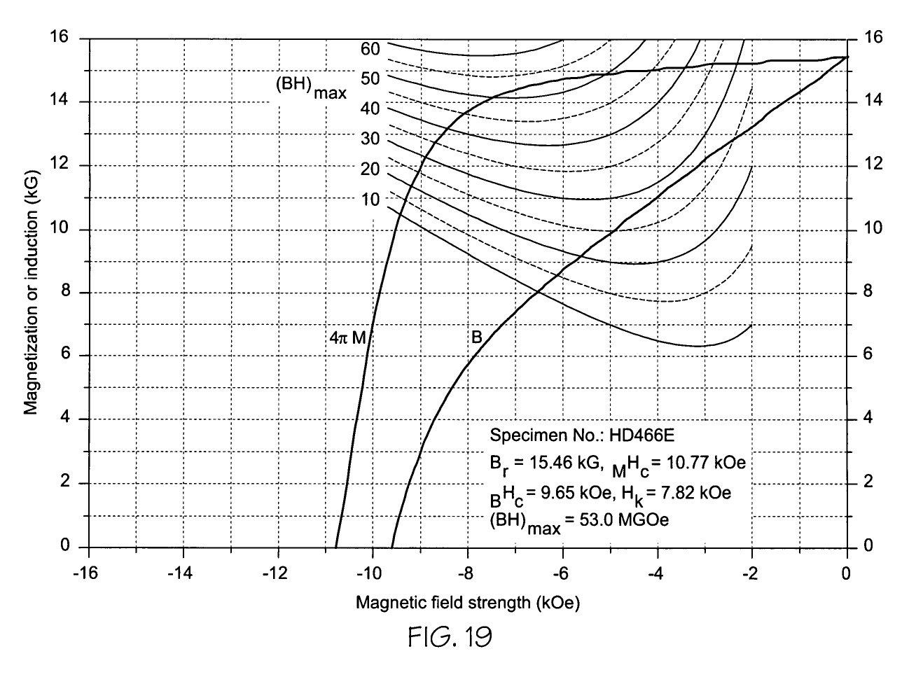

FIG. 19 shows the demagnetization curves of a hot compacted and hot deformed Nd13.5Fe₈₀Ga_{0.5}B₆/α-Fe [91.7 wt %/8.3 wt %] magnet synthesized using a Nd—Fe—Ga—B alloy powder having a Nd content of 13.5 at % blended with 8.3 wt % α-Fe powder. The hot compaction was performed at 640° C. for 2 minutes, and the hot deformation was performed at 940° C. for 5 minutes with height reduction of 71%.

The overall Nd content of the magnet is very close to the stoichiometric value of 11.76 at %. However, as shown in FIG. 12, the x-ray diffraction pattern of a random powder specimen of this magnet exhibits a tetragonal 2:14:1 crystal structure coupled with a strong α-Fe peak, indicating the existence of a relatively large fraction of the α-Fe phase. The existence of the α-Fe phase can also be seen directly from an SEM image as shown in FIG. 16.

Because the hot compaction and hot deformation time was short, there was not enough time for the diffusion to complete and to reach a chemical equilibrium condition. Thus, the hot compacted and hot deformed anisotropic magnets can have a rare earth-rich phase and a magnetically soft phase simultaneously, even though the overall rare earth content may be less than stoichiometric. Even when the total rare earth content is greater than the stoichiometric, the magnet can still contain a magnetically soft phase. Therefore, the Nd content of this type of Nd—Fe—B/α-Fe nanocomposite magnet can be in a broad range from about 2 at % up to about 14 at % as shown in FIG. 58. Thus, it should be appreciated that nanocomposite rare earth permanent magnets formed in the manner as described can be in a chemical non-equilibrium condition. The rare earth contents in nanocomposite magnets, such as Nd₂Fe₁₄B/α-Fe, Nd₂Fe₁₄B/Fe—Co, Pr₂Fe₁₄B/α-Fe, Pr₂Fe₁₄B/Fe—Co, PrCo₅/Co, SmCo₅/Fe—Co, SmCo₇/Fe—Co, Sm₂Co₁₇/Fe—Co, can be less than, equal to, or greater than the stoichiometry.

### EXAMPLE 10

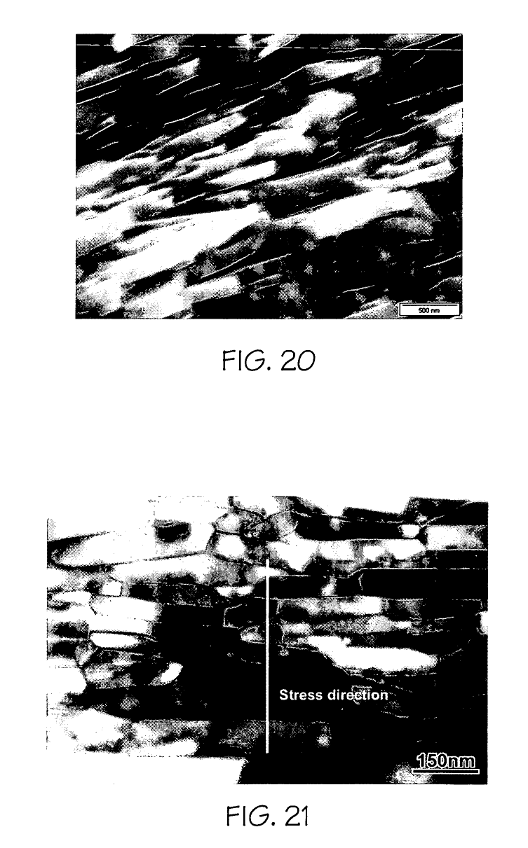

FIG. 20 shows an SEM micrograph of the fracture surface of a hot compacted and hot deformed Nd_{13.5}Fe₈₀Ga_{0.5}B₆/α-Fe [92.1 wt %/7.9 wt %] magnet, demonstrating elongated and aligned grains. The hot compaction was performed at 640° C. for 2 minutes, and the hot deformation was performed at 940° C. for 2 minutes with height reduction of 71%.

FIG. 21 shows a TEM micrograph of a hot compacted and hot deformed Nd₁₄Fe_{79.0}Ga_{0.5}B₆/α-Fe [95 wt %/5 wt %] magnet, demonstrating elongated and aligned grains. The hot compaction was performed at 550° C. for 2 minutes and the hot deformation was performed at 900° C. for 2 minutes with height reduction of 70%. The magnet has (BH)ₘₐₓ=48 MGOe.

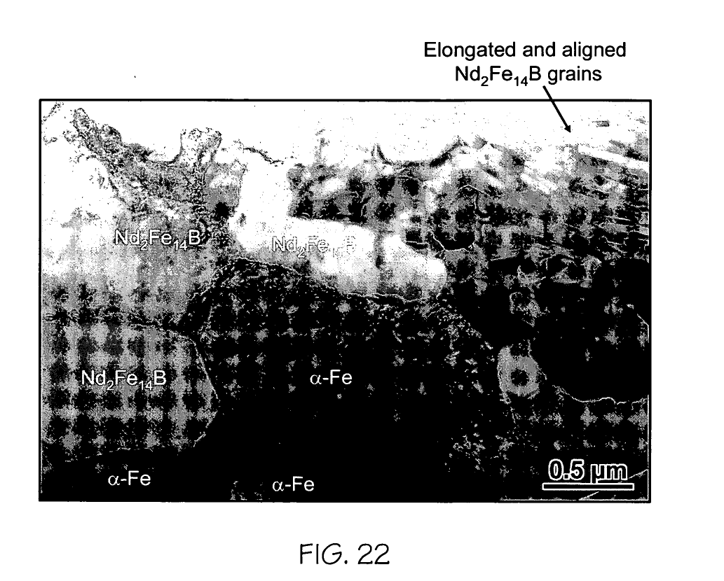

FIG. 22 shows a TEM micrograph of the same nanocomposite magnet as shown in FIG. 21, demonstrating the hard/soft interface characterized as large α-Fe particles and large Nd₂Fe₁₄B grains at the interface. The upper right corner shows elongated and aligned 2:14:1 grains. This figure shows that the hard/soft interface exchange coupling is much stronger than previously understood.

### EXAMPLE 11

FIG. 23 shows a comparison of the XRD patterns of bulk anisotropic magnets of (1) a hot deformed nanocomposite Nd_{10.8}Pr_{0.6}Dy_{0.2}Fe_{76.1}Co_{6.3}Ga_{0.2}Al_{0.2}B_{5.6} magnet synthesized using an alloy powder with a total rare earth content of 13.5 at % and an alloy powder with a total rare earth content of 6 at %; (2) a hot deformed Nd_{13.5}Fe₈₀Ga_{0.5}B₆/α-Fe [91.7 wt %/8.3 wt %] magnet synthesized using an alloy powder with Nd=13.5 at % blended with 8.3 wt % α-Fe powder; and (3) a commercial sintered Nd—Fe—B magnet.

As shown in FIG. 23, the second magnet demonstrates better grain alignment than the first magnet, and it is similar to that of the sintered Nd—Fe—B magnet.

### EXAMPLE 12

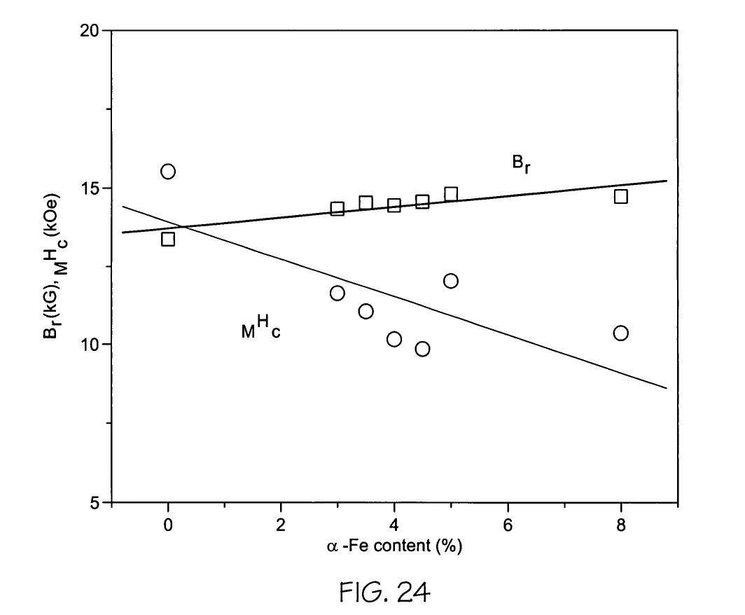

FIG. 24 summarizes the effect of α-Fe content (wt %) on Bᵣ and _{M}H_{C} of nanocomposite Nd₁₄Fe_{79.0}Ga_{0.5}B₆/α-Fe magnets.

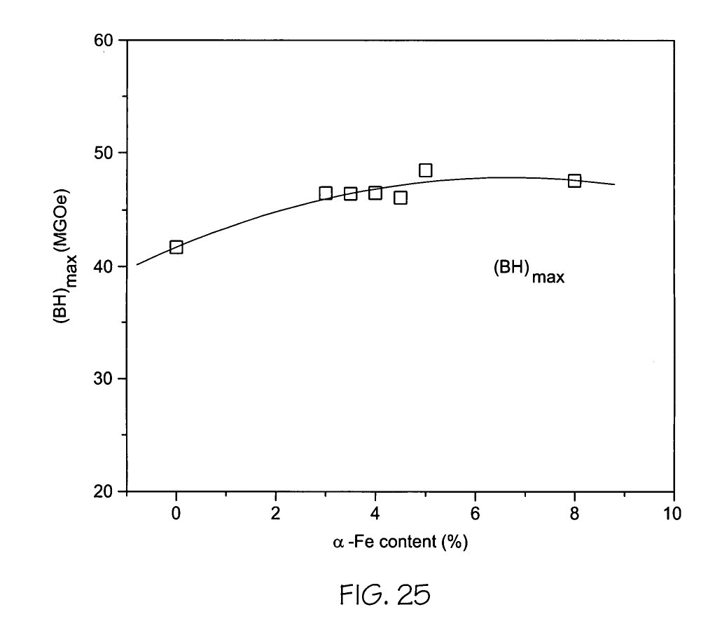

FIG. 25 summarizes the effect of α-Fe content (wt %) on (BH)ₘₐₓ of nanocomposite Nd₁₄Fe_{79.0}Ga_{0.5}B₆/α-Fe magnets.

### EXAMPLE 13

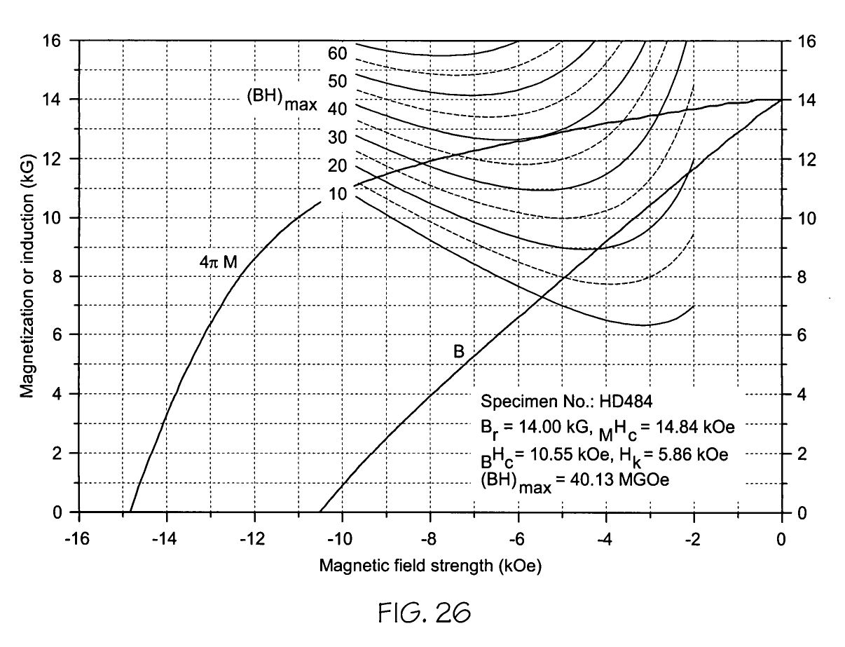

FIG. 26 shows the demagnetization curves of a Nd_{12.5}Dy_{1.5}Fe_{79.5}Ga_{0.5}B₆/α-Fe [87.1 wt %/12.9 wt %] magnet synthesized using a Nd_{12.5}Dy_{1.5}Fe_{79.5}Ga_{0.5}B₆ alloy powder blended with 12.9 wt % α-Fe powder. The hot compaction was performed at 640° C. for 2 minutes, and the hot deformation was performed at 930° C. for 3 minutes with height reduction of 71%.

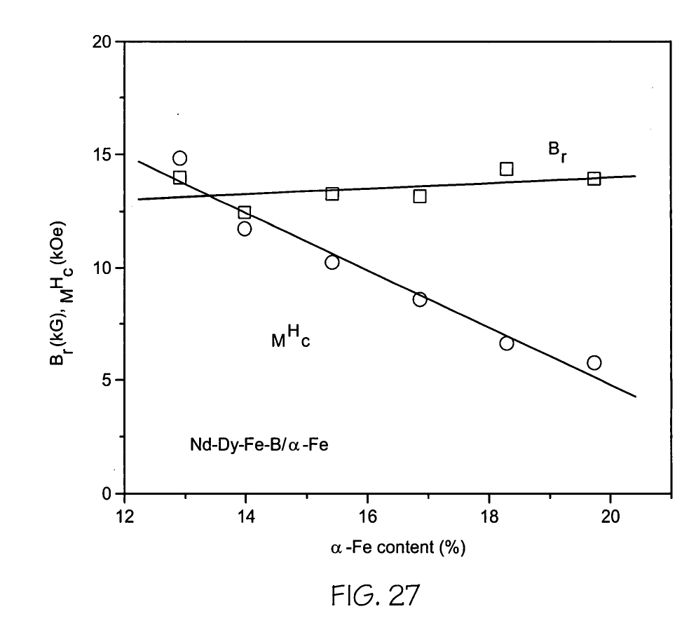

FIG. 27 summarizes the effect of α-Fe content (wt %) on Bᵣ and _{M}H_{C} of nanocomposite Nd_{12.5}Dy_{1.5}Fe_{79.5}Ga_{0.5}B₆/α-Fe [87.1 wt %/12.9 wt %] magnets.

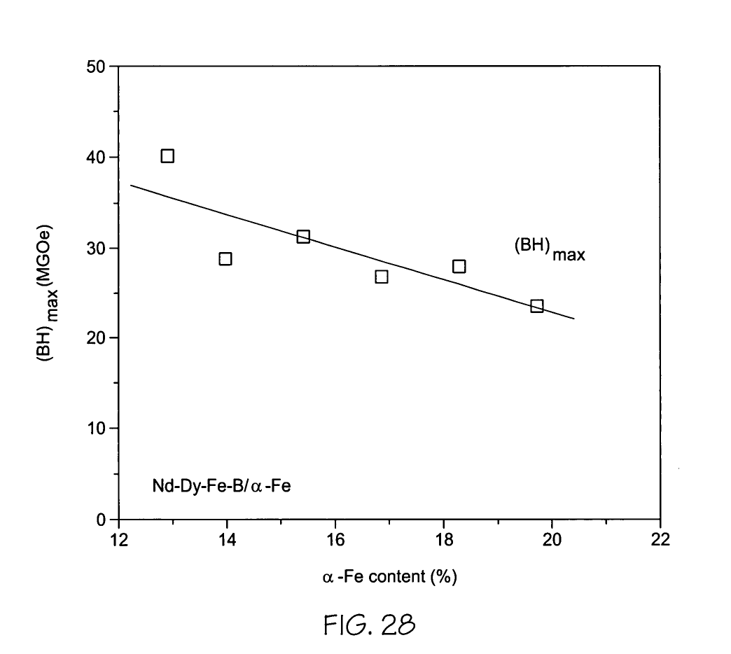

FIG. 28 summarizes the effect of α-Fe content (wt %) on (BH)ₘₐₓ of nanocomposite Nd_{12.5}Dy_{1.5}Fe_{79.5}Ga_{0.5}B₆/α-Fe [87.1 wt %/12.9 wt %] magnets.

### EXAMPLE 14

In addition to the α-Fe powder, Fe—Co alloy powder can be blended with Nd—Fe—B powder in making nanocomposite Nd—Fe—B/Fe—Co magnets.

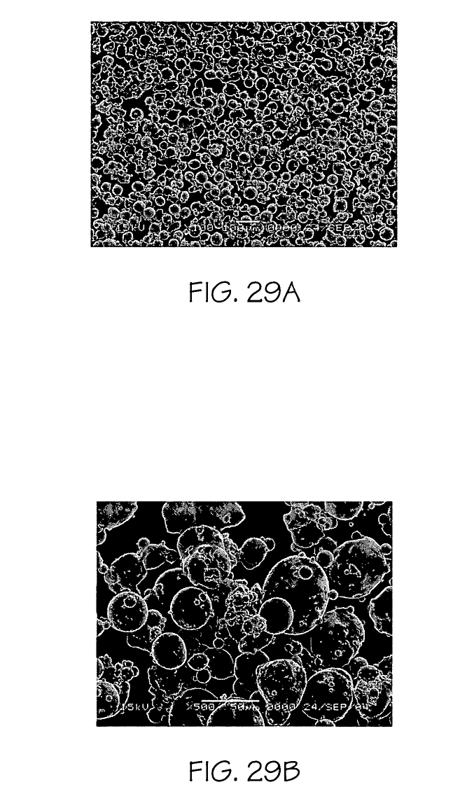

FIG. 29 shows an SEM micrograph of Fe—Co powder used in making nanocomposite Nd—Fe—B/Fe—Co magnets in this invention. The powder particle size is ≦50 micrometers.

FIG. 69 shows the SEM fracture surface of a Fe—Co particle demonstrating nanograins.

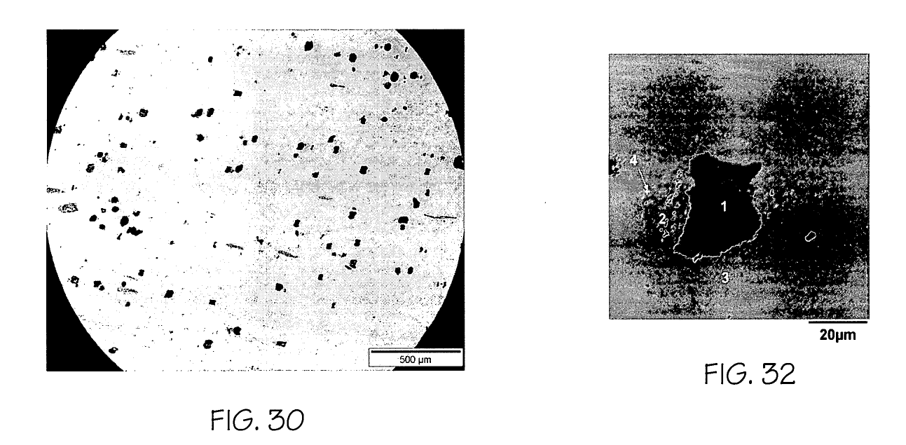

FIG. 30 shows an SEM back scattered electron image of a Nd_{13.5}Fe₈₀Ga_{0.5}B₆/Fe—Co [95 wt %/5 wt %] magnet with (BH)ₘₐₓ=48 MGOe. The magnet was synthesized using a Nd_{13.5}Fe₈₀Ga_{0.5}B₆ alloy powder blended with 5 wt % of Fe—Co powder. The dark gray phase is Fe—Co. The hot compaction was performed at 630° C. for 2 minutes, and the hot deformation was performed at 930° C. for 3 minutes with height reduction of 71%. The hot deformation appears to play only a small role in improving the distribution of the soft Fe—Co phase.

FIG. 31 shows SEM micrographs of the Nd_{13.5}Fe₈₀Ga_{0.5}B₆/Fe—Co [95 wt %/5 wt %] magnet. Apparently, the Fe—Co phase remains in the original sphere shape after the hot deformation.

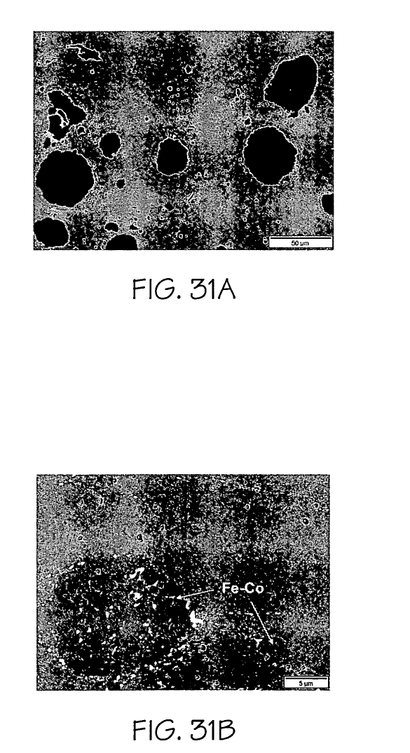

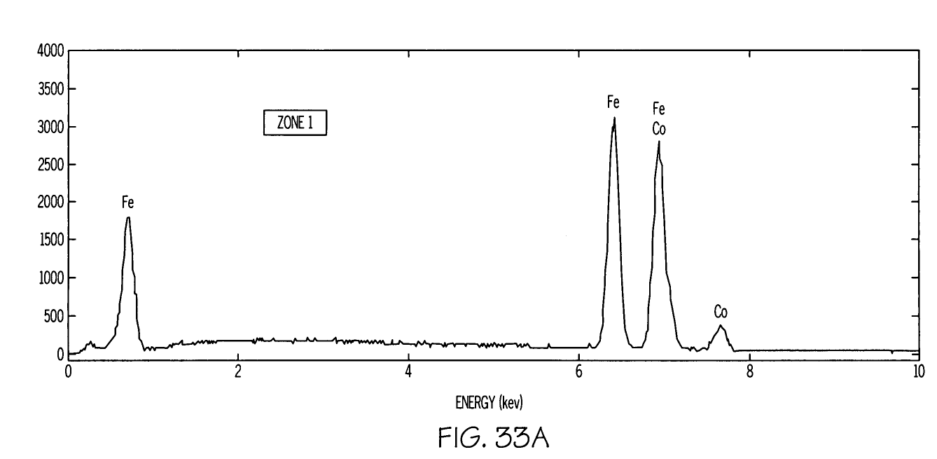

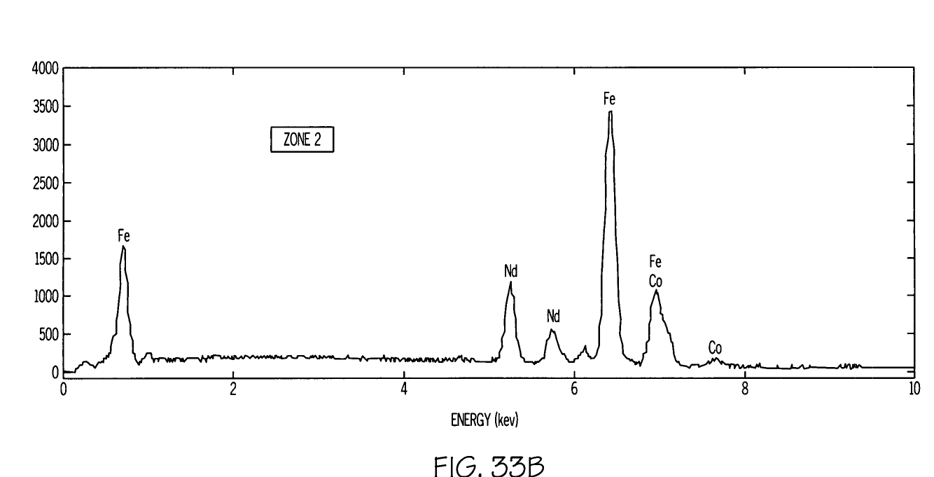

FIG. 32 shows an SEM back scattered electron image of the Nd_{13.5}Fe₈₀Ga_{0.5}B₆/Fe—Co [95 wt %/5 wt %] magnet showing different zones in the magnet. Zone 1 is pure Fe—Co; zone 2is a diffusion area; zone 3 is a Nd—Fe—B matrix phase; and zone 4 white spots are rich in Nd and oxygen.

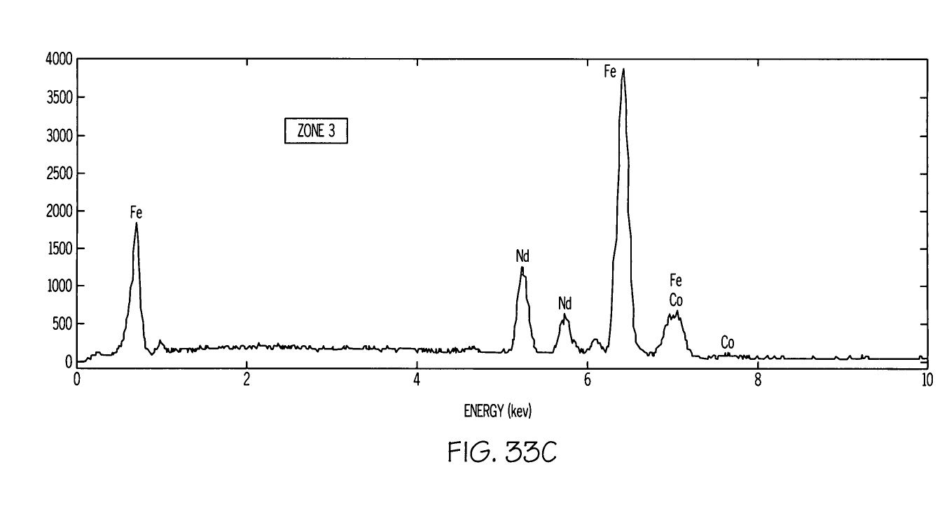

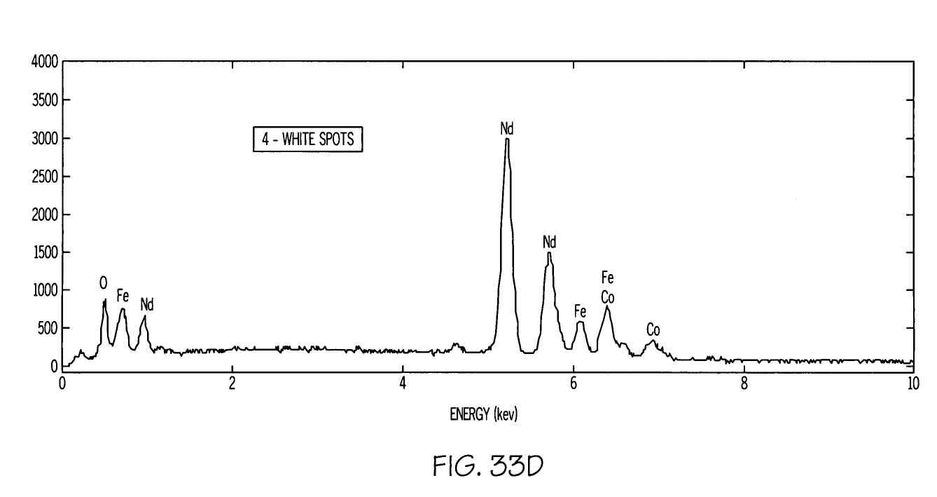

FIG. 33 shows results of SEM/EDS analysis of different zones for Nd_{13.5}Fe₈₀Ga_{0.5}B₆/Fe—Co [95 wt %/5 wt %] magnet.

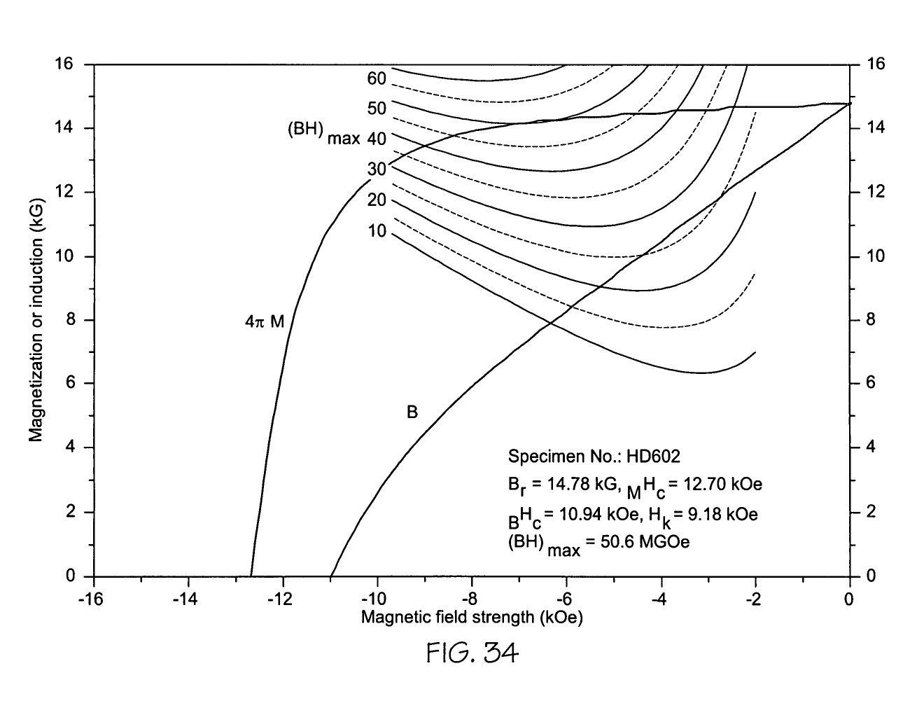

FIG. 34 shows the demagnetization curves of an anisotropic Nd₁₄Fe_{79.5}Ga_{0.5}B₆/Fe—Co [97 wt %/3 wt %] magnet. The hot compaction was performed at 600° C. for 2 minutes, and the hot deformation was performed at 920° C. for 2.5 minutes with height reduction of 71%. The smooth demagnetization curve indicates effective hard/soft interface exchange coupling. Considering the very large particle size of the Fe—Co powder (≦50 microns) as shown in FIGS. 29-32, the interface exchange coupling between the hard Nd₁₄Fe_{79.5}Ga_{0.5}B₆ and soft Fe—Co phase is much stronger than previously understood. According to the existing interface exchange coupling models, the upper limit of the magnetically soft phase is around 20-30 nanometers. However, in the Nd₁₄Fe_{79.5}Ga_{0.5}B₆/Fe—Co [97 wt %/3 wt %] magnet synthesized in this invention, the Fe—Co phase can be as large as up to 50 microns, roughly 2000 times as large as the size in the existing models.

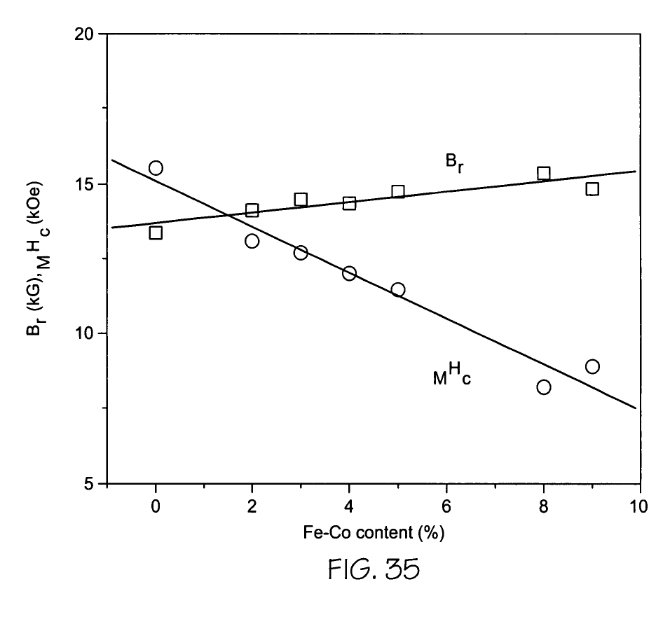

FIG. 35 shows the effect of Fe—Co content (wt %) on Bᵣ and _{M}H_{c} of nanocomposite Nd₁₄Fe_{79.5}Ga_{0.5}B₆/Fe—Co magnets.

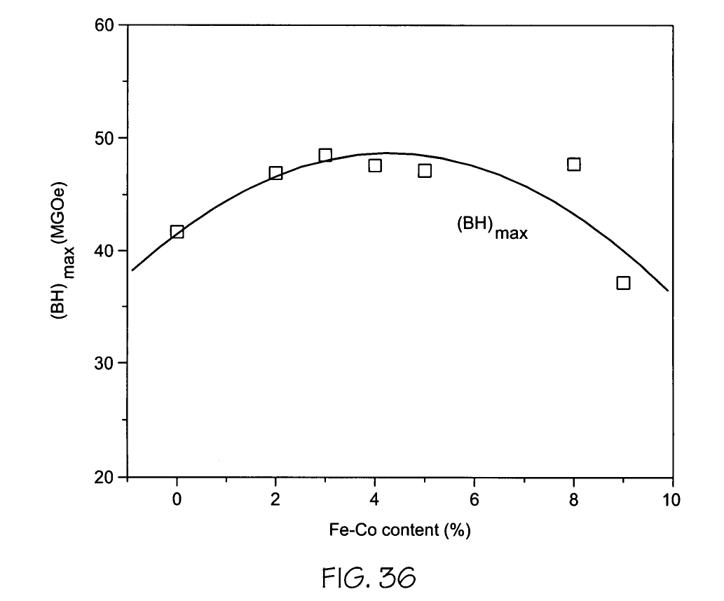

FIG. 36 shows the effect of Fe—Co content (wt %) on (BH)ₘₐₓ of nanocomposite Nd₁₄Fe_{79.5}Ga_{0.5}B₆/Fe—Co magnets.

### EXAMPLE 15

FIG. 42 shows SEM micrographs and the result of SEM/EDS analysis of Nd_{13.5}Fe₈₀Ga_{0.5}B₆ powder after RF sputtering for 8 hours using a Fe—Co—V target. The composition of the Fe—Co—V alloy used in this invention is: 49 wt % Fe, 49 wt % Co, and 2 wt % V.

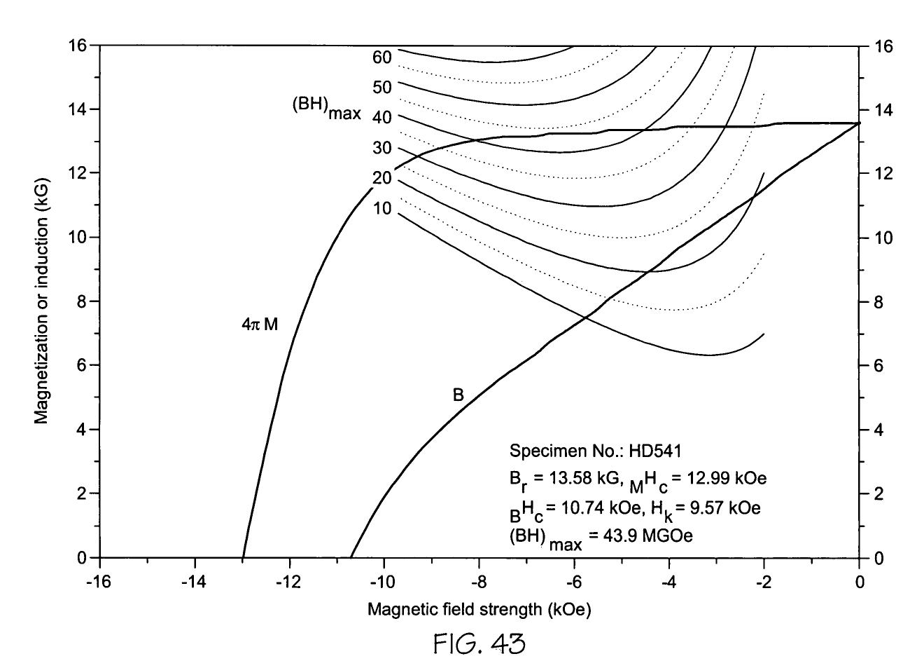

FIG. 43 shows the demagnetization curves of a nanocomposite Nd₁₄Fe_{79.5}Ga_{0.5}B₆/Fe—Co—V magnet prepared after RF sputtering for 3 hours. The hot compaction was performed at 580° C. for 2 minutes, and the hot deformation was performed at 920° C. for 2 minutes with height reduction of 77%.

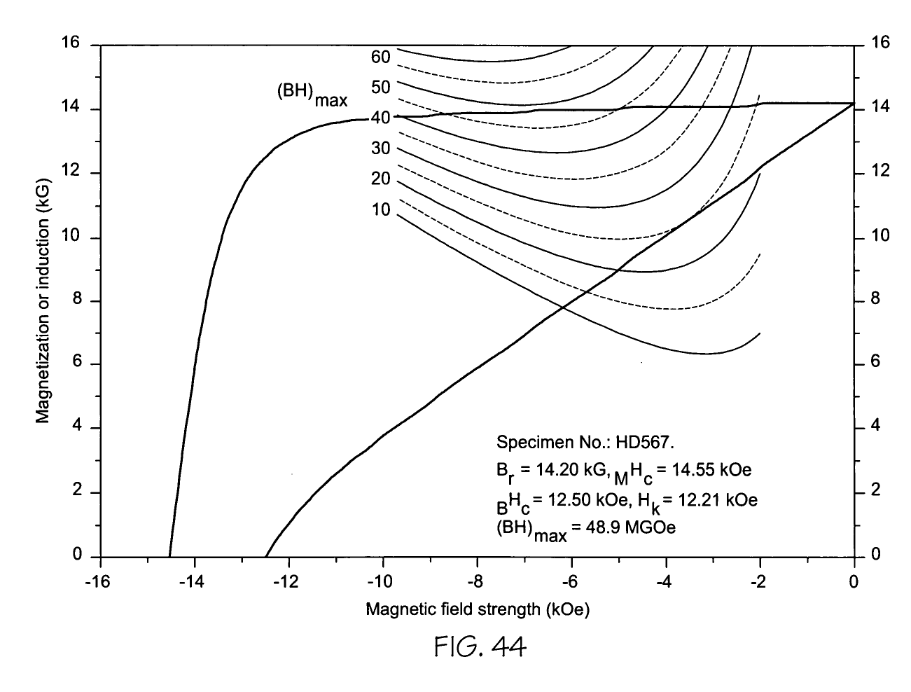

FIG. 44 shows the demagnetization curves of a nanocomposite Nd₁₄Fe_{79.5}Ga_{0.5}B₆/Fe—Co—V magnet prepared after DC sputtering for 8 hours. The hot compaction was performed at 600° C. for 2 minutes, and the hot deformation was performed at 930° C. for 2 minutes with height reduction of 71%.

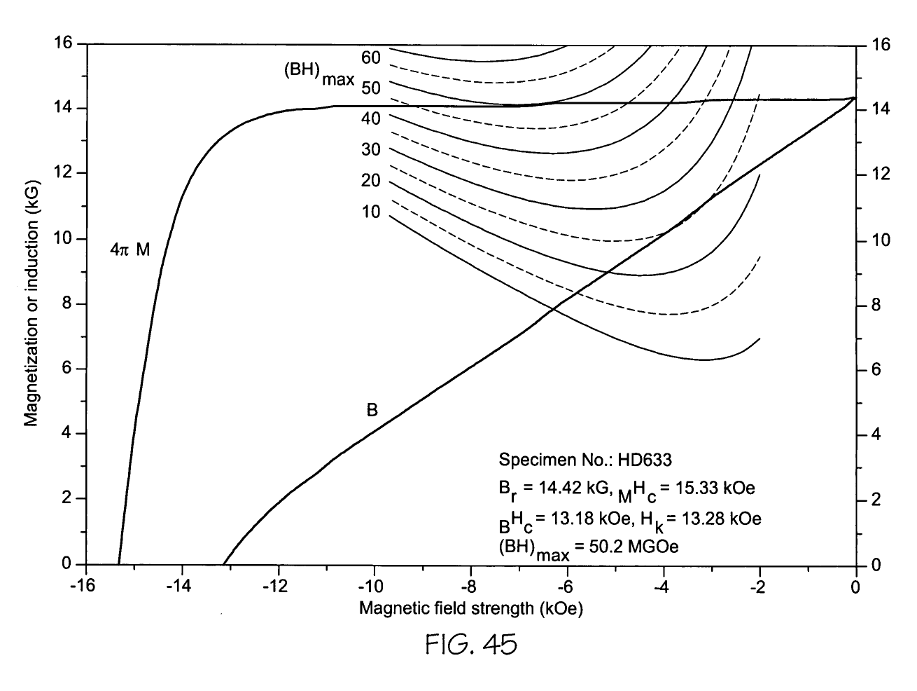

FIG. 45 shows the demagnetization curves of a nanocomposite Nd₁₄Fe_{79.5}Ga_{0.5}B₆/Fe—Co—V magnet prepared after DC sputtering for 21 hours. The hot compaction was performed at 630° C. for 2 minutes, and the hot deformation was performed at 940° C. for 5 minutes with height reduction of 71%.

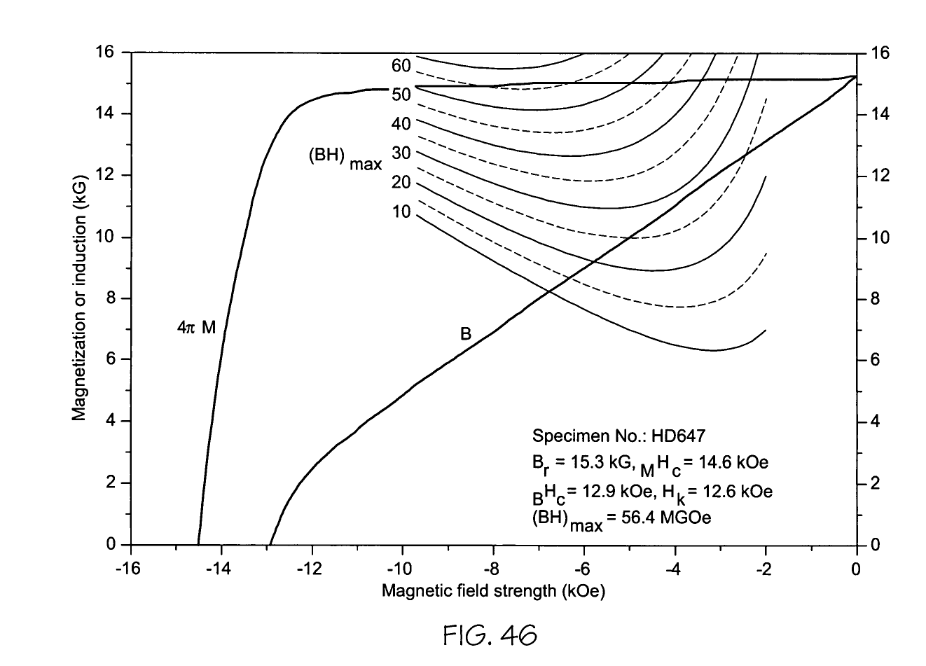

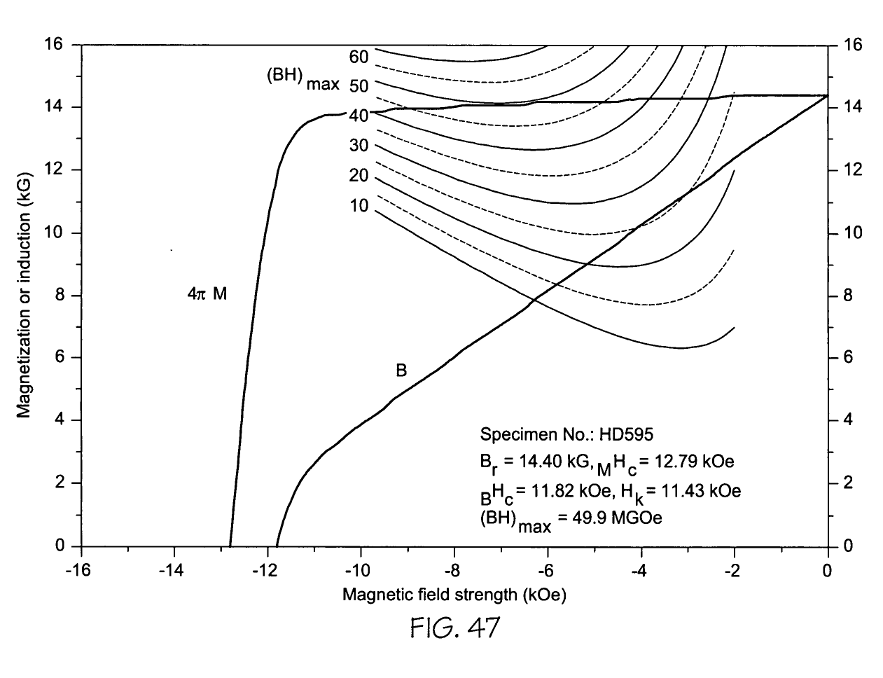

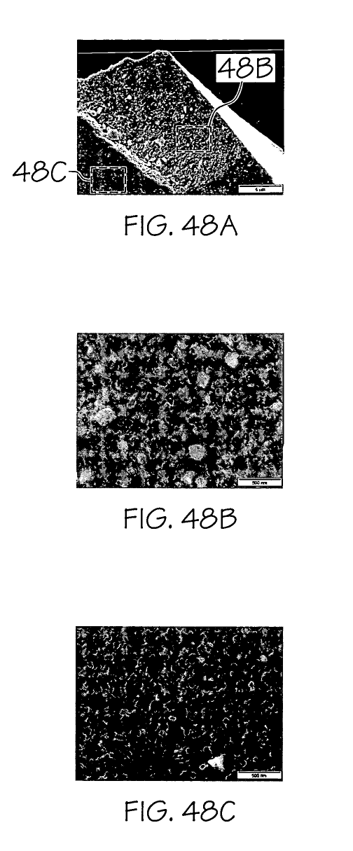

FIG. 46 shows the demagnetization curves of a nanocomposite Nd₁₄Fe_{79.5}Ga_{0.5}B₆/Fe—Co—V magnet prepared after DC sputtering for 21 hours. The hot compaction was performed at 630° C. for 2 minutes, and the hot deformation was performed at 930° C. for 6 minutes with height reduction of 71%.

### EXAMPLE 16

FIG. 47 shows the demagnetization curves of a nanocomposite Nd₁₄Fe_{79.5}Ga_{0.5}B₆/Fe—Co—V magnet prepared after pulsed laser deposition for 6 hours. The hot compaction was performed at 630° C. for 2 minutes, and the hot deformation was performed at 930° C. for 5.5 minutes with height reduction of 68%.

### EXAMPLE 17

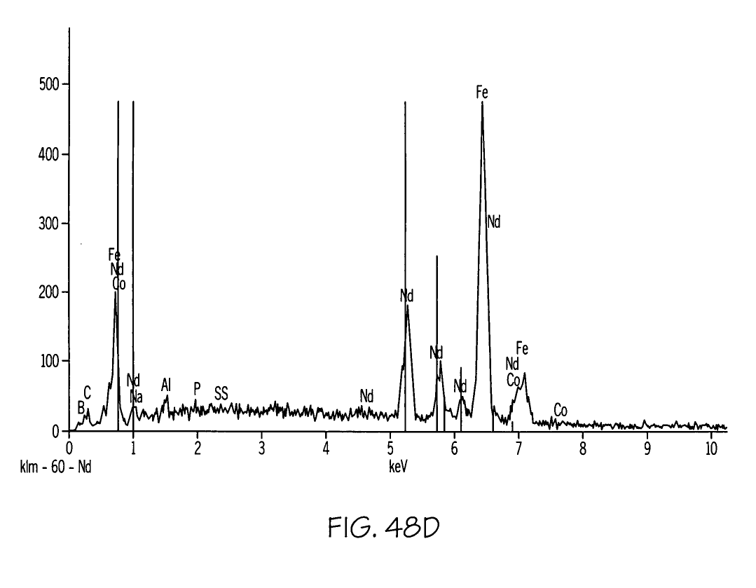

FIG. 48 shows SEM micrographs and the result of SEM/EDS analysis of a Nd₁₄Fe_{79.5}Ga_{0.5}B₆ powder particle after chemical coating in a FeSO₄—CoSO₄—NaH₂PO₂—Na₃C₆H₅O₇ solution for 1 hour at room temperature.

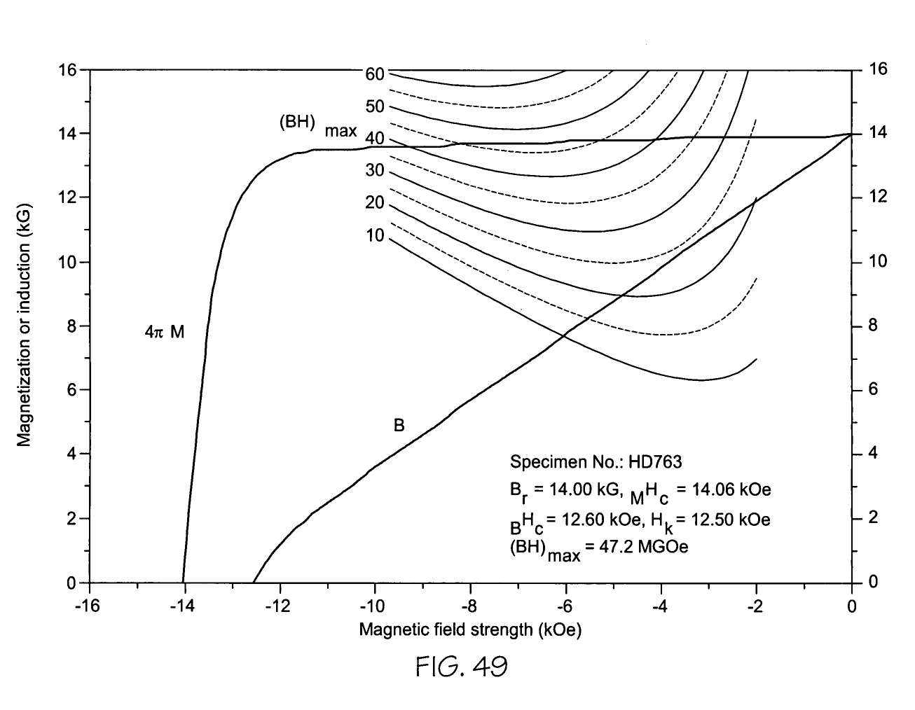

FIG. 49 shows the demagnetization curves of a nanocomposite Nd₁₄Fe_{79.5}Ga_{0.5}B₆/Fe—Co magnet prepared after chemical coating in a FeSO₄—CoSO₄—NaH₂PO₂—Na₃C₆H₅O₇ solution for 15 minutes. The hot compaction was performed at 620° C. for 2 minutes, and the hot deformation was performed at 950° C. for 3 minutes with height reduction of 71%.

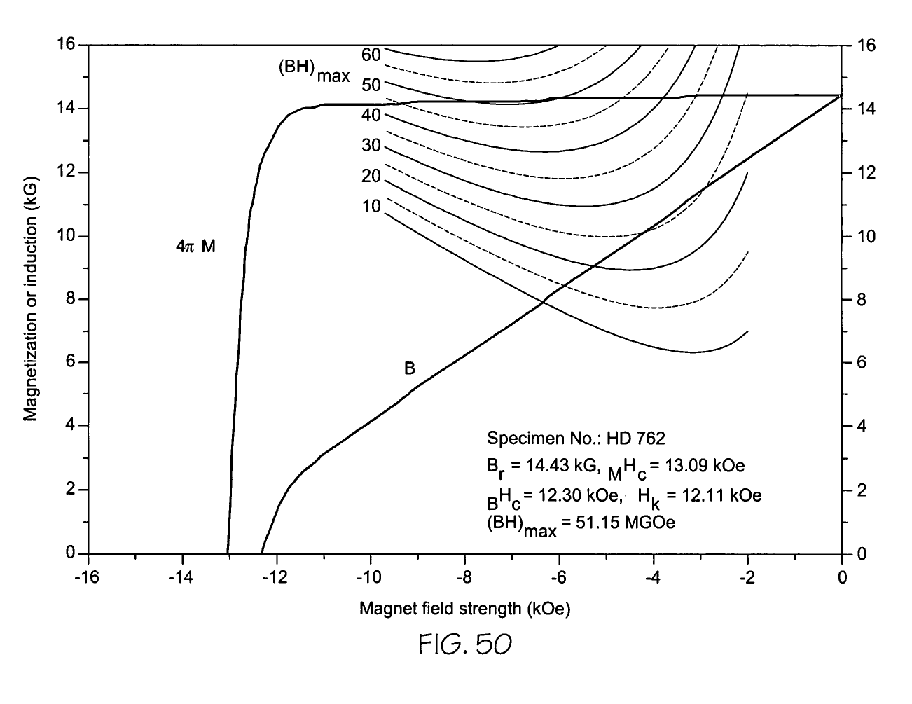

FIG. 50 shows the demagnetization curves of a nanocomposite Nd₁₄Fe_{79.5}Ga_{0.5}B₆/Fe—Co magnet prepared after chemical coating in a FeSO₄—CoSO₄—NaH₂PO₂—Na₃C₆H₅O₇ solution for 1 hour. The hot compaction was performed at 620° C. for 2 minutes, and the hot deformation was performed at 950° C. for 5 minutes with height reduction of 71%.

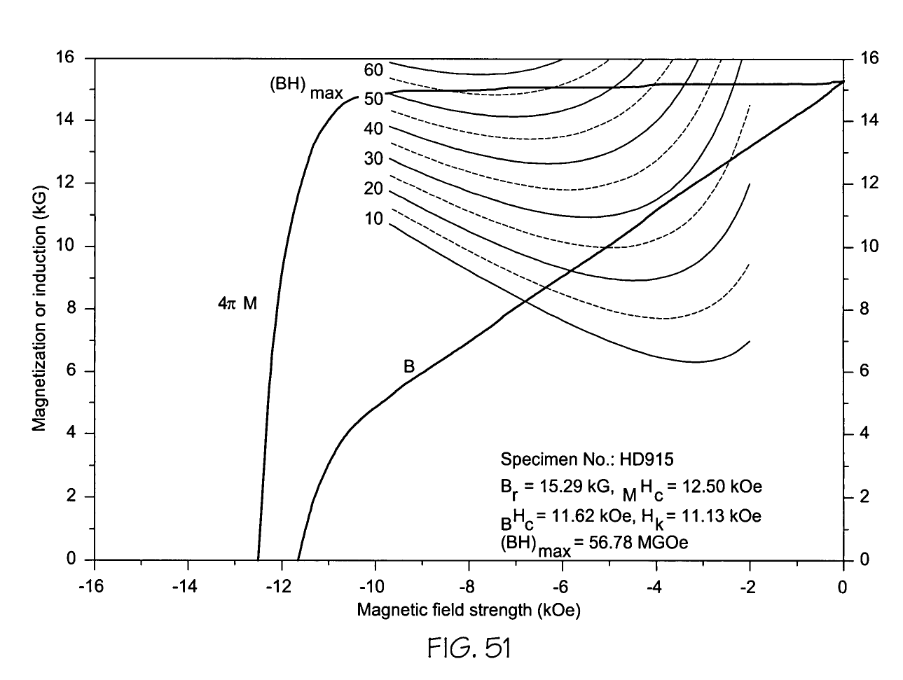

FIG. 51 shows the demagnetization curves of a nanocomposite Nd₁₄Fe_{79.5}Ga_{0.5}B₆/Fe—Co magnet prepared after chemical coating in a FeCl₂—CoCl₂—NaH₂PO₂—Na₃C₆H₅O₇ solution for 2 hours at 50° C. The hot compaction was performed at 620° C. for 2 minutes, and the hot deformation was performed at 960° C. for 5 minutes with height reduction of 71%.

### EXAMPLE 18

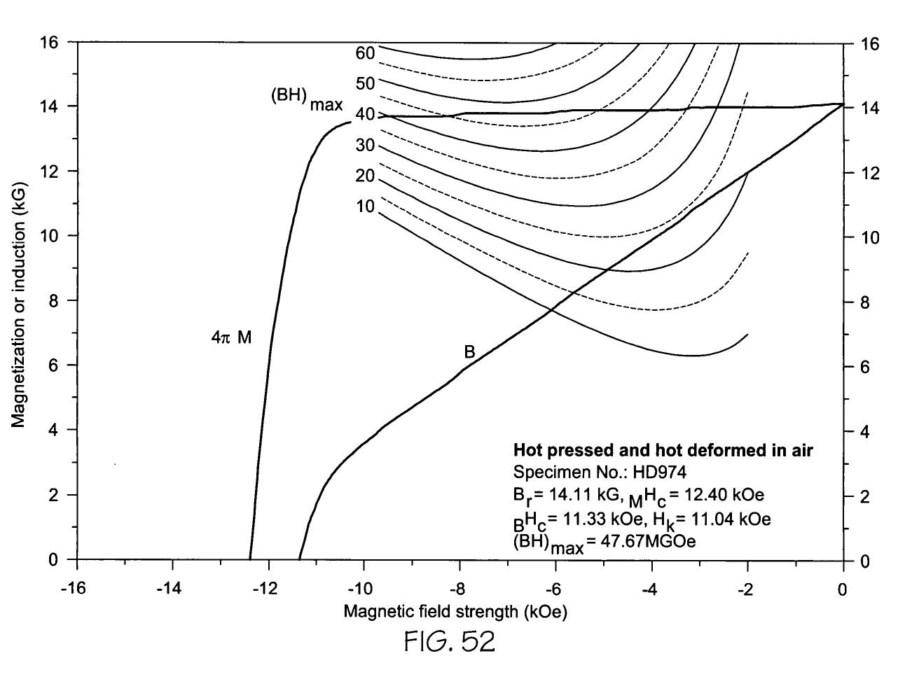

FIG. 52 shows the demagnetization curves of a nanocomposite Nd₁₄Fe_{79.5}Ga_{0.5}B₆/Fe—Co magnet prepared after chemical coating in a FeCl₂—CoCl₂—NaH₂PO₂—Na₃C₆H₅O₇ solution for 1 hour. The hot compaction was performed at 620° C. for 2 minutes in air, and the hot deformation was performed at 960° C. for 4 minutes in air with height reduction of 71%.

### EXAMPLE 19

Powder coating can be done by using electric coating.

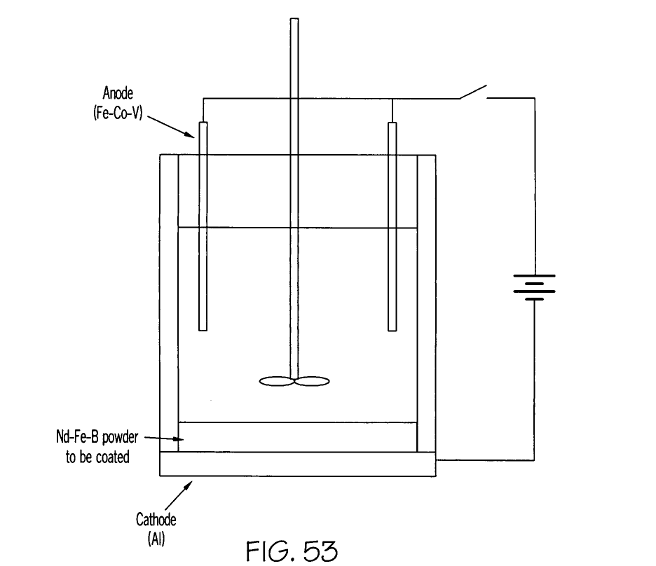

FIG. 53 is a schematic illustration of apparatus used for electric coating. For electric coating, α-Fe or Fe—Co—V alloy were used as anodes.

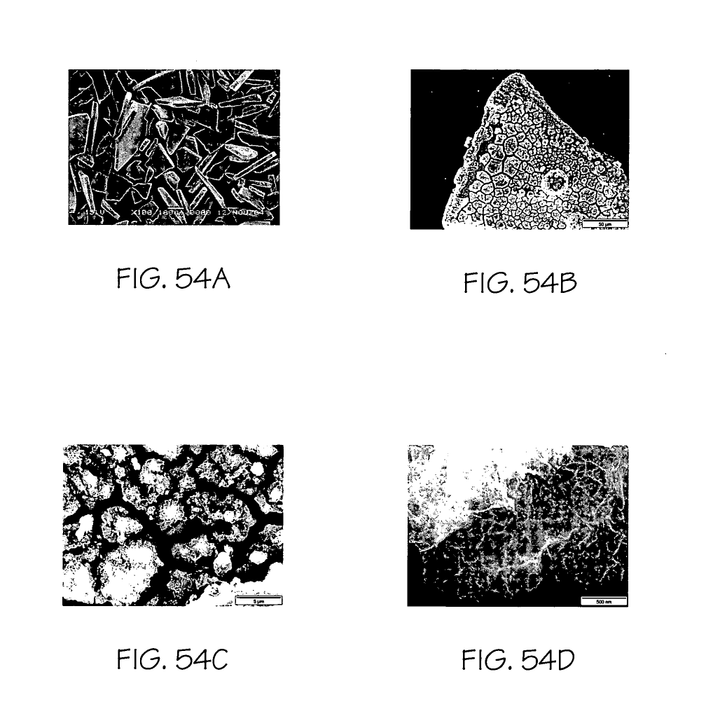

FIG. 54 shows SEM micrographs of Nd₁₄Fe_{79.5}Ga_{0.5}B₆ powder after electric coating in a FeCl₂—CoCl₂—MnCl₂—H₃BO₃ solution for 0.5 hour at room temperature.

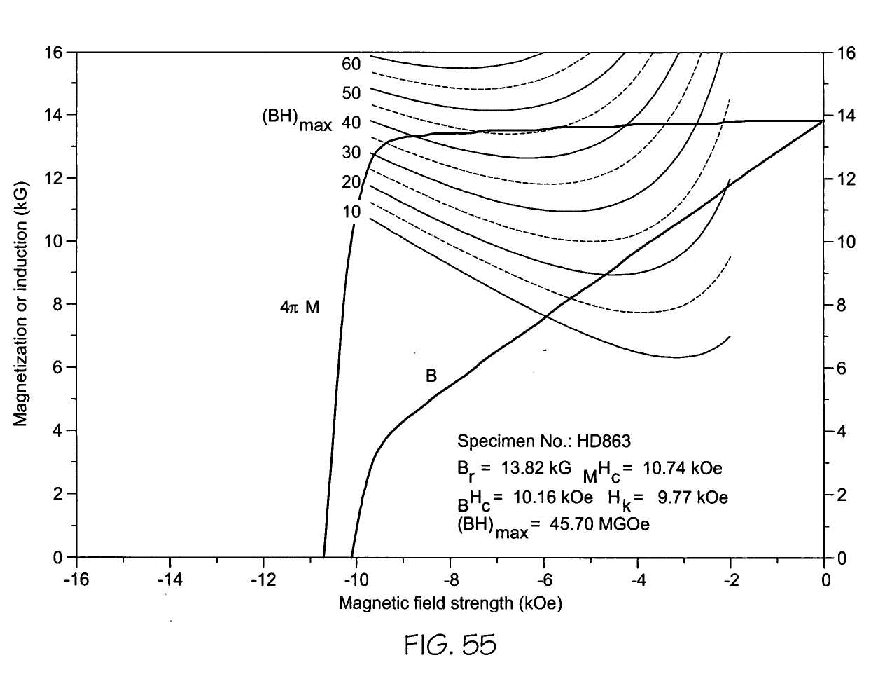

FIG. 55 shows the demagnetization curves of Nd₁₄Fe_{79.5}Ga_{0.5}B₆/Fe—Co—V magnet prepared after electric coating in a FeCl₂—CoCl₂—MnCl₂—H₃BO₃ solution for 0.5 hour at room temperature under 2 volt-1 amp. The hot compaction was performed at 620° C. for 2 minutes, and the hot deformation was performed at 960° C. for 6 minutes with height reduction of 71%.

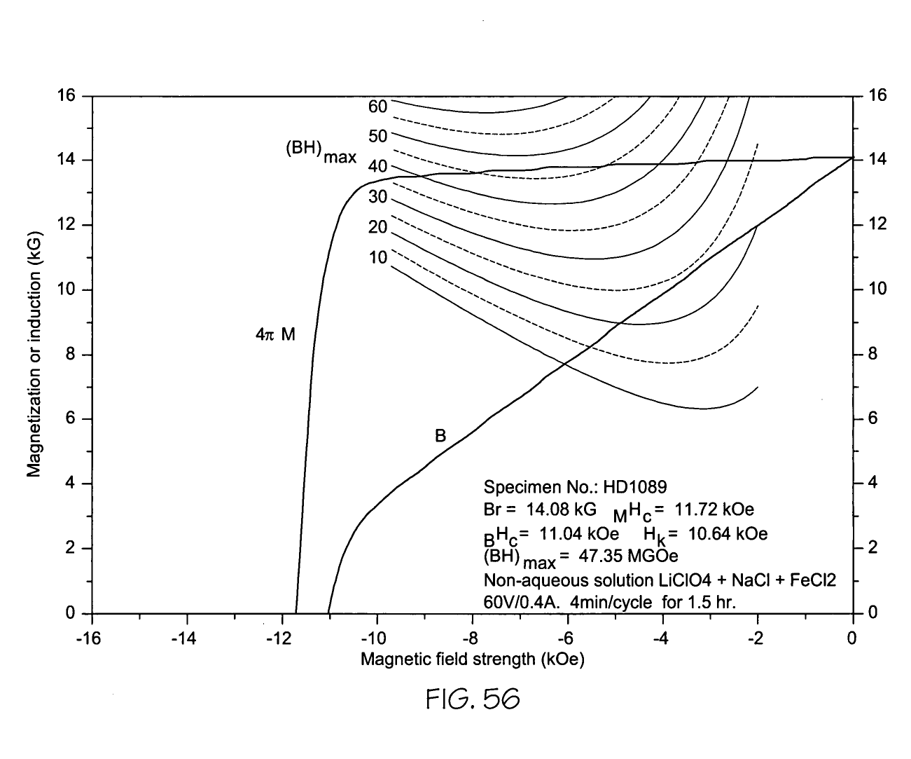

FIG. 56 shows the demagnetization curves of Nd₁₄Fe_{79.5}Ga_{0.5}B₆/α-Fe magnet prepared after electric coating in a non-aqueous LiClO₄—NaCl—FeCl₂ solution for 1.5 hour at room temperature under 60 volt-0.4 amp. The hot compaction was performed at 600° C. for 2 minutes, and the hot deformation was performed at 940° C. for 2.5 minutes with height reduction of 71%.

FIG. 57 shows an SEM micrograph of a Nd₁₄Fe_{79.5}Ga_{0.5}B₆/α-Fe magnet prepared after electric coating in a FeCl₂—CoCl₂—MnCl₂—H₃BO₃ solution for 0.5 hour at room temperature under 3 volt-2 amp. The hot compaction was performed at 620° C. for 2 minutes, and the hot deformation was performed at 960° C. for 7 minutes with height reduction of 71%.

Having described the invention in detail and by reference to preferred embodiments thereof, it will be apparent that modifications and variations are possible without departing from the scope of the invention.

What is claimed is:

1. A bulk, anisotropic, nanocomposite, rare earth permanent magnet comprising at least one magnetically hard phase and at least one magnetically soft phase, wherein the at least one magnetically hard phase comprises at least one rare earth-transition metal compound, wherein the composition of the magnetically hard phase specified in atomic percentage is RₓT_{100-x-y}M_{y}, and wherein R is selected from rare earths, yttrium, scandium, or combinations thereof, wherein T is selected from one or more transition metals, wherein M is selected from an element in groups IIIA, IVA, VA, or combinations thereof, and wherein x is greater than a stoichiometric amount of R in a corresponding rare earth-transition metal compound, wherein y is 0 to about 25, and wherein the at least one magnetically soft phase comprises at least one soft magnetic material containing Fe, Co, or Ni.

2. The bulk, anisotropic, nanocomposite, rare earth permanent magnet of claim 1 wherein the at least one rare earth-transition metal compound has an atomic ratio of R:T or R:T:M selected from 1:5, 1:7, 2:17, 2:14:1, or 1:12.

3. The bulk, anisotropic, nanocomposite, rare earth permanent magnet of claim 1, wherein the rare earth is selected from Nd, Sm, Pr, Dy, La, Ce, Gd, Tb, Ho, Er, Eu, Tm, Yb, Lu, mischmetal, or combinations thereof.

4. The bulk, anisotropic, nanocomposite, rare earth permanent magnet of claim 1 wherein the rare earth-transition metal compound is selected from Nd₂Fe₁₄B, Pr₂Fe₁₄B, PrCo₅, SmCo₅, SmCo₇, or Sm₂Co₁₇.

5. The bulk, anisotropic, nanocomposite, rare earth permanent magnet of claim 1, wherein T is selected from Fe, Co, Ni, Ti, Zr, Hf, V, Nb, Ta, Cr, Mo, W, Mn, Cu, Zn, Cd, or combinations thereof.

6. The bulk, anisotropic, nanocomposite, rare earth permanent magnet of claim 1 wherein M is selected from B, Al, Ga, In, Tl, C, Si, Ge, Sn, Sb, Bi, or combinations thereof.

7. The bulk, anisotropic, nanocomposite, rare earth permanent magnet of claim 1 wherein the at least one soft magnetic material is selected from α-Fe, Fe—Co, Fe—B, an alloy containing Fe, Co, or Ni, or combinations thereof.

8. The bulk, anisotropic, nanocomposite, rare earth permanent magnet of claim 1 wherein the magnetically soft phase is distributed in a matrix of the magnetically hard phase.

9. The bulk, anisotropic, nanocomposite, rare earth permanent magnet of claim 1 wherein a fraction of the magnetically soft phase in the bulk, anisotropic, nanocomposite, rare earth permanent magnet is from about 0.5 vol % to about 80 vol %.

10. The bulk, anisotropic, nanocomposite, rare earth permanent magnet of claim 8 wherein the at least one magnetically soft phase has a dimension from about 2 nanometers to about 100 micrometers.

11. The bulk, anisotropic, nanocomposite, rare earth permanent magnet of claim 8 wherein the magnetically soft phase is distributed as layers in a matrix of the magnetically hard phase.

12. The bulk, anisotropic, nanocomposite, rare earth permanent magnet of claim 9 wherein a thickness of the layers is from about 2 nanometers to about 20 micrometers.

13. The bulk, anisotropic, nanocomposite, rare earth permanent magnet of claim 1 wherein magnetically hard grains are distributed in a matrix of the magnetically soft phase.

14. The bulk, anisotropic, nanocomposite, rare earth permanent magnet of claim 1 wherein the bulk, anistropic, nanocomposite, rare earth permanent magnet has an average grain size in a range of about 1 nm to about 1000 nm.

15. The bulk, anisotropic, nanocomposite, rare earth permanent magnet of claim 1 wherein the bulk, anisotropic, nanocomposite, rare earth permanent magnet is in a chemically non-equilibrium condition.

16. The bulk, anisotropic, nanocomposite, rare earth permanent magnet of claim 15 wherein the bulk, anisotropic, nanocomposite, rare earth permanent magnet contains a rare earth-rich phase and the magnetically soft phase.

17. The bulk, anisotropic, nanocomposite, rare earth permanent magnet of claim 1 wherein the intrinsic coercivity is greater than about 5 kOe.

18. The bulk, anisotropic, nanocomposite, rare earth permanent magnet of claim 1 wherein the remanence is greater than about 10 kG.

19. The bulk, anisotropic, nanocomposite, rare earth permanent magnet of claim 1 wherein the maximum energy product is greater than about 15 MGOe.

20. An anisotropic, nanocomposite rare earth permanent magnet powder prepared by crushing the bulk, anisotropic, nanocomposite rare earth permanent magnet of claim 1.

21. A bonded, anisotropic, nanocomposite, rare earth permanent magnet prepared by adding a binder to the anisotropic, nanocomposite, rare earth permanent magnet powder of claim 20 and compacting the anisotropic, nanocomposite, rare earth permanent magnet powder and the binder in a magnetic field.

22. A method of making a bulk, anisotropic, nanocomposite, rare earth permanent magnet comprising at least one magnetically hard phase and at least one magnetically soft phase, wherein the at least one magnetically hard phase comprises at least one rare earth-transition metal compound, wherein a composition of the magnetically hard phase specified in atomic percentage is RₓT_{100-x-y}M_{y}, and wherein R is selected from rare earths, yttrium, scandium, or combination thereof, wherein T is selected from one or more transition metals, wherein M is selected from an element in groups IIIA, IVA, VA, or combinations thereof, and wherein x is greater than a stoichiometric amount of R in a corresponding rare earth-transition metal compound, wherein y is 0 to about 25; wherein the at least one magnetically soft phase comprises at least one soft magnetic material containing Fe, Co, or Ni; the method comprising:
providing at least one powdered rare earth-transition metal alloy wherein the rare earth-transition metal alloy has an effective rare earth content in an amount greater than a stoichiometric amount in a corresponding rare earth-transition metal compound;
providing at least one powdered material selected from a rare earth-transition metal alloy wherein the rare earth-transition metal alloy has an effective rare earth content in an amount less than a stoichiometric amount in a corresponding rare earth-transition metal compound; a soft magnetic material; or combinations thereof;
blending the at least one powdered rare earth-transition metal alloy and the at least one powdered material; and
performing at least one operation selected from compacting the blended at least one powdered rare earth-transition metal alloy and at least one powdered material to form a bulk, isotropic, nanocomposite, rare earth permanent magnet; or hot deforming the bulk, isotropic, nanocomposite, rare earth permanent magnet, or the blended at least one powdered rare earth-transition metal alloy and at least one powdered material, to form the bulk, anisotropic, nanocomposite, rare earth permanent magnet.

23. The method of claim 22 wherein the powdered rare earth-transition metal alloy is prepared using a process selected from a rapid solidification process, mechanical alloying, or mechanical milling.

24. The method of claim 22 wherein a particle size of the powdered rare earth-transition metal alloy is from about 1 micrometer to about 1000 micrometers.

25. The method of claim 22 wherein the at least one powdered material is at least one soft magnetic material.

26. The method of claim 25 wherein the soft magnetic material is selected from α-Fe, Fe—Co, Fe—B, or an alloy containing Fe, Co, or Ni, or a combination thereof.

27. The method of claim 25 wherein a particle size of the soft magnetic material is from about 10 nanometers to about 100 micrometers, and a grain size is less than about 1000 nanometers.

28. A method of making a bulk, anisotropic nanocomposite, rare earth permanent magnet comprising at least one magnetically hard phase and at least one magnetically soft phase, wherein the at least one magnetically hard phase comprises at least one rare earth-transition metal compound, wherein a composition of the magnetically hard phase specified in atomic percentage is RₓT_{100-x-y}M_{y} and wherein R is selected from rare earths, yttrium, scandium, or combination thereof, wherein T is selected from one or more transition metals, wherein M is selected from an element in groups IIIA, IVA, VA, or combinations thereof, and wherein x is greater than the stoichiometric amount of R in a corresponding rare earth-transition metal compound, and y is 0 to about 25; wherein the at least one magnetically soft phase comprises at least one soft magnetic material containing Fe, Co, or Ni, the method comprising:
providing at least one powdered rare earth-transition metal alloy wherein the rare earth-transition metal alloy has an effective rare earth content in an amount not less than a stoichiometric amount in a corresponding rare earth-transition metal compound;
coating the at least one powdered rare earth-transition metal alloy with at least one soft magnetic material; and
performing at least one operation selected from compacting the coated at least one powdered rare earth-transition metal alloy; or hot deforming the compacted coated at least one powdered rare earth-transition metal alloy, or the coated at least one powdered rare earth-transition metal alloy.
